(19) United States
(12) Patent Application Publication
(10) Pub. No.: US 2016/0219458 A1
(43) Pub. Date: Jul. 28, 2016

(54) METHODS AND APPARATUS FOR RADIO LINK CONTROL SWITCHING

(71) Applicant: QUALCOMM Incorporated, San Diego, CA (US)

(72) Inventors: Keiichi Kubota, Weybridge (GB); Gavin Bernard Horn, La Jolla, CA (US)

(21) Appl. No.: 14/997,271

(22) Filed: Jan. 15, 2016

Related U.S. Application Data
(60) Provisional application No. 62/107,992, filed on Jan. 26, 2015.
(60) Provisional application No. 62/116,262, filed on Feb. 13, 2015.

(51) Int. Cl. H04W 28/06; H04W 28/02

(52) U.S. Cl. CPC H04W 28/06; H04W 28/0273; H04W 80/02

(57) ABSTRACT

Methods and apparatus for radio link control switching are disclosed. The methods and apparatus determining a communication mode at a first device for a radio bearer or packet flow of a radio connection between the first device and a second device including determining whether to operate in a first communication mode providing packet loss recovery or packet reorder, or to operate in a second communication mode providing no packet loss recovery. A first indication is transmitted to the second device related to whether the first communication mode or the second communication mode should be used for the packet flow, and a second indication is transmitted to the second device indicating whether packet buffering is to be maintained. The communication mode for the packet flow of the radio connection between the first communication mode and second communication mode is then switched based at least on the first indication.

### CLAIM OF PRIORITY UNDER 35 U.S.C. §119

The present application for patent claims priority to Provisional Application No. 62/107,992 entitled “METHOD AND APPARATUS FOR RADIO LINK CONTROL SWITCHING” filed Jan. 26, 2015, and Provisional Application No. 62/116,262 entitled “METHOD AND APPARATUS FOR RADIO LINK CONTROL SWITCHING” filed Feb. 13, 2015, and both assigned to the assignee hereof and hereby expressly incorporated by reference herein.

### TECHNICAL FIELD

The present disclosure relates generally to communication systems, and more particularly, to methods and apparatus for radio link control (RLC) switching.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power). These multiple access technologies have been adopted in various telecommunication standards to provide a common protocol that enables different wireless devices to communicate on a municipal, national, regional, and even global level. Emerging telecommunication standards include fourth generation (4G) technologies such as Long Term Evolution (LTE), and fifth generation (5G) technologies.

LTE, in particular, is a set of enhancements to the Universal Mobile Telecommunications System (UMTS) mobile standard advanced by Third Generation Partnership Project (3GPP). It is designed to better support mobile broadband Internet access by improving spectral efficiency, lowering costs, improving services, making use of new spectrum, and better integrating with other open standards using OFDMA on the downlink (DL), SC-FDMA on the uplink (UL), and multiple-input multiple-output (MIMO) antenna technology.

The radio protocol architecture for LTE, for example, consists of various layers of protocols enabling the handling of data and signaling from either user or control planes in a wireless device for transmission and reception over the wireless interface (e.g., an Evolved Universal Terrestrial Radio Access network (E-UTRAN) in the case of LTE). At the user plane side, for example, an application on the wireless device creates data packets that are processed by protocols such as TCP, UDP, and IP. At the control plane side, a radio resource control (RRC) protocol determines the signaling messages that are exchanged between one wireless device and another wireless device. In both cases, the information is then processed by various protocols including a packet data convergence protocol (PDCP), a radio link control (RLC) protocol, and a medium access control (MAC) protocol, before being passed to the physical layer (PHY) for transmission over the wireless interface. At the receiver side, the same protocols are used to take received PHY layer signals and ultimately convert these back to application layer data or signaling information.

Regarding the RLC protocol layer, in particular, this layer provides segmentation of data structures (e.g., Service Data units (SDUs)) from either the RRC or PDCP protocol layers into RLC protocol data units (PDUs) used for communication with the MAC layer. The RLC layer can be configured to generally operate according to three modes: (1) a transparent (TM) mode that simply passes packets between the RRC or PDCP and the MAC layer without organization into PDUs; (2) an unacknowledged mode (UM) that segments and organizes data into PDUs, but does not require acknowledgement of successful receipt of packets from a receiver, and (3) an acknowledged mode (AM) that, in addition to the organization into PDUs, requires an acknowledgement from a receiver and allows retransmission if the packet is not acknowledged by the receiver (e.g., Automatic Repeat Request (ARQ)).

Concerning AM operation of the RLC AM, while affording higher reliability, this operation also requires larger buffering of PDUs that are needed for retransmissions, and may also cause throughput degradation due to delays in acknowledgements and status reporting. Delayed status reporting, for example, may occur due to a number of various conditions, such as bad radio conditions for a reverse direction, a bad configuration of the status reporting, or a bad data scheduler implementation that fails to prioritize the status reporting over transmission of user data. UM operation on the other hand, doesn't have the buffering and throughput problems associated with AM operation. Nonetheless, it is not ideal to always use UM for the data transfer as UM doesn't have the retransmission functionality, and can lead to reliability degradation due to lost and unrecoverable packets.

Accordingly, there exists a need to be able to effectively and efficiently switch between at least AM and UM modes in a Radio Link Control in order to afford the ability to increase throughput when conditions permit and reduce the need for buffering large amounts of data, while ensuring reliability when also needed.

### SUMMARY

According to an aspect, a method for wireless communication is disclosed herein. The method includes determining at a first device a communication mode for at least a first packet flow of a radio connection between the first device and a second device that includes determining whether to operate in a first communication mode providing at least one of packet loss recovery and/or packet reorder, or to operate in a second communication mode providing no packet loss recovery. Further, the method features transmitting a first indication to the second device related to whether the first communication mode or the second communication mode should be used for the first packet flow of the radio connection, and a second indication to the second device indicating whether packet buffering is to be maintained. Also, the method includes switching the communication mode for the first packet flow of the radio connection between the first communication mode and second communication mode based at least on the first indication.

According to another aspect, a wireless device is disclosed herein, where the device includes a communications interface configured to communicate over a wireless network, and processing circuitry in communication with or coupled to the communications interface. The processing circuitry is configured to determine a communication mode for at least a first packet flow of a radio connection between the wireless device and another second wireless device that includes determining whether to operate in a first communication mode providing at least one of packet loss recovery and/or packet reorder, or to operate in a second communication mode providing no packet loss recovery. Also, the processing circuitry is configured to transmit a first indication to the second wireless device related to whether the first communication mode or the second communication mode should be used for the first packet flow of the radio connection, and a second indication to the second device indicating whether packet buffering is to be maintained. The processing circuitry is also configured to switch the communication mode for the first packet flow of the radio bearer connection between the first communication mode and second communication mode based at least on the first indication.

In yet another aspect, a method for wireless communication is disclosed including receiving at a first wireless device an indication signal from a second wireless device indicating to switch a communication mode of a first packet flow of a radio connection between the first and second wireless devices from one of a first or second communication mode to the other of the first or second communication modes, wherein the first communication mode provides packet loss recovery and packet reorder and the second communication mode provides no packet loss recovery. The method also features switching the communication mode for the first packet flow of the radio connection according to the indication signal, wherein the indication signal includes a first indication of which of the first or second communication modes to switch to and a second indication indicating whether packet buffering is to be maintained in at least the first wireless device.

According to yet another aspect, a wireless communications device is disclosed that includes a communications interface configured to communicate over a wireless network, and processing circuitry communicatively coupled to the communications interface. The processing circuitry is configured to receive at the wireless communications device an indication signal from a second wireless communications device indicating to switch a communication mode of at least a first packet flow of a radio connection between the first and second wireless devices from one of a first or second communication mode to the other of the first or second communication modes, wherein the first communication mode provides packet loss recovery and packet reorder and the second communication mode provides no packet loss recovery. The processing circuitry is also configured to switch the communication mode for the first packet flow of the radio connection according to the indication signal, wherein the indication signal includes a first indication of which of the first or second communication modes to switch to and a second indication indicating whether packet buffering is to be maintained in at least the first wireless device.

### BRIEF DESCRIPTION OF THE DRAWINGS

FIG. 1 is a diagram illustrating an example of a network architecture.

FIG. 2 is a diagram illustrating an example of an access network.

FIG. 3 is a diagram illustrating an example of a radio protocol architecture for the user and control planes.

FIG. 4 illustrates an example of a protocol stack that may be implemented in a communication device operating in the example of LTE packet-switched networks.

FIG. 5 is a diagram illustrating an example of an evolved Node B and user equipment deployed in an access network.

FIG. 6 illustrates a timing diagram showing interactions between an RLC entity and another peer RLC entity during AM.

FIG. 7 illustrates a state diagram in accordance with certain aspects disclosed herein.

FIG. 8 illustrates a timing diagram showing interactions between an RLC entity and another peer RLC entity in accordance with certain aspects disclosed herein.

FIG. 9 illustrates a diagram showing the data transfer and reception flows between a first device and a second device in accordance with certain aspects disclosed herein.

FIG. 10 illustrates a diagram of an RLC data PDU in accordance with certain aspects disclosed herein.

FIG. 11 illustrates a diagram of a header in an RLC control PDU in accordance with certain aspects disclosed herein.

FIG. 12 illustrates another RLC PDU in accordance with certain aspects disclosed herein.

FIG. 13 illustrates a timing diagram showing interactions between a transmitter and a receiver in accordance with certain aspects disclosed herein.

FIG. 14 is a block diagram illustrating an example of a wireless device configured to implement various aspects disclosed herein.

FIG. 15 is a flow diagram of a first method of wireless communication.

FIG. 16 is a flow diagram of a second method of wireless communication.

### DETAILED DESCRIPTION

The detailed description set forth below is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well-known structures and components are shown in block diagram form in order to avoid obscuring such concepts.

Several aspects of telecommunication systems will now be presented with reference to various apparatus and methods. These apparatus and methods will be described in the following detailed description and illustrated in the accompanying drawings by various blocks, modules, components, circuits, steps, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented with a “processing system” that includes one or more processors. Examples of processors include microprocessors, microcontrollers, digital signal processors (DSPs), field programmable gate arrays (FPGAs), programmable logic devices (PLDs), application specific integrated circuit (ASIC), system on chip (SOC), state machines, gated logic, discrete hardware circuits, and other suitable hardware configured to perform the various functionality described throughout this disclosure. One or more processors in the processing system may execute software. Software shall be construed broadly to mean instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

Accordingly, in one or more exemplary embodiments, the functions described may be implemented in hardware, software, firmware, or any combination thereof. If implemented in software, the functions may be stored on or encoded as one or more instructions or code on a computer-readable medium. Computer-readable media includes computer storage media. Storage media may be any available media that can be accessed by a computer. By way of example, and not limitation, such computer-readable media can include RAM, ROM, EEPROM, CD-ROM or other optical disk storage, magnetic disk storage or other magnetic storage devices, or any other medium that can be used to carry or store desired program code in the form of instructions or data structures and that can be accessed by a computer. Disk and disc, as used herein, includes compact disc (CD), laser disc, optical disc, digital versatile disc (DVD), and floppy disk where disks usually reproduce data magnetically, while discs reproduce data optically with lasers. Combinations of the above should also be included within the scope of computer-readable media.

Certain aspects of the disclosure are applicable to not only LTE, fourth generation (4G), and earlier networks, but also to newer generations of radio access technologies (RATs), including fifth generation (5G) and later networks. The configuration and operation of a 4G LTE network architecture is described herein by way example, and for the purpose of simplifying descriptions of certain aspects that may apply to multiple RATs.

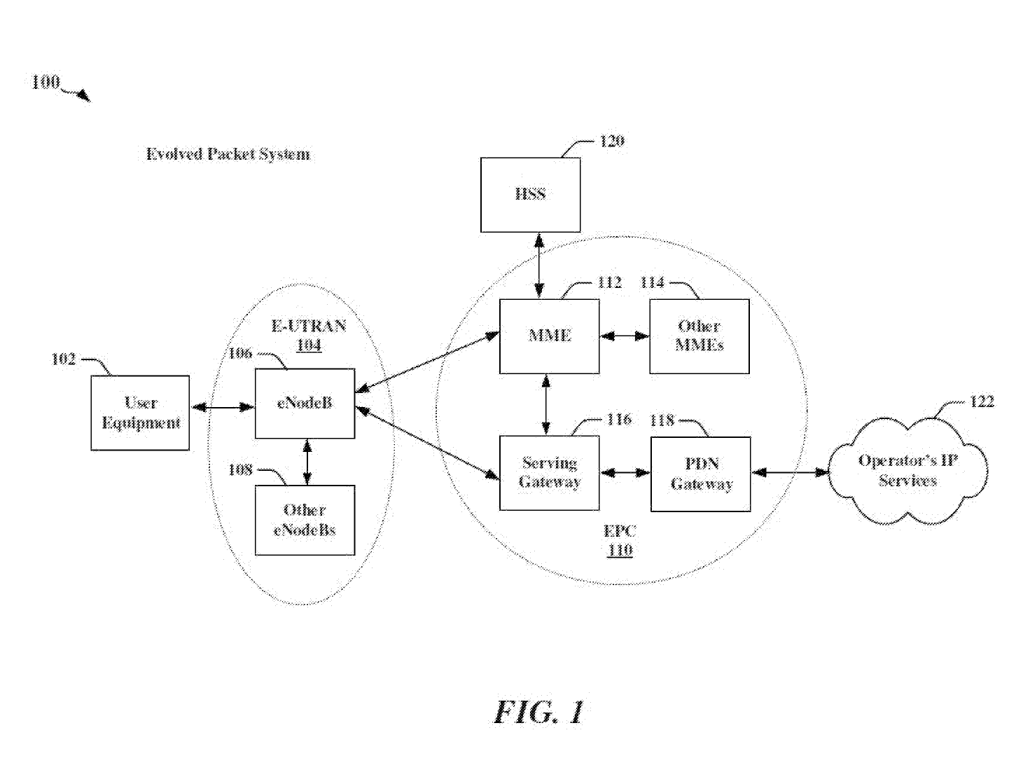

FIG. 1 is a diagram illustrating an exemplary LTE network architecture 100. The LTE network architecture 100 may be referred to as an Evolved Packet System (EPS) 100. The EPS 100 may include one or more user equipment (UE) 102, an Evolved UMTS Terrestrial Radio Access Network (E-UTRAN) 104, an Evolved Packet Core (EPC) 110, a Home Subscriber Server (HSS) 120, and an Operator's IP Services 122. The EPS can interconnect with other access networks, but for simplicity those entities/interfaces are not shown. As shown, the EPS provides packet-switched services, however, as those skilled in the art will readily appreciate, the various concepts presented throughout this disclosure may be extended to networks providing circuit-switched services.

The E-UTRAN 104 includes the evolved Node B (eNB) 106 and other eNBs 108. The eNB 106 provides user and control planes protocol terminations toward the UE 102. The eNB 106 may be connected to the other eNBs 108 via a backhaul (e.g., an X2 interface). The eNB 106 may also be referred to as a Node B, a base station, a base transceiver station, a radio base station, a radio transceiver, a transceiver function, a basic service set (BSS), an extended service set (ESS), or some other suitable terminology. The eNB 106 provides an access point to the EPC 110 for a UE 102. Examples of UEs 102 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a data card, a USB dongle, a mobile wireless router or any other similar functioning device. The UE 102 may also be referred to by those skilled in the art as a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology.

The eNB 106 is connected by an S1 interface to the EPC 110. The EPC 110 includes a Mobility Management Entity (MME) 112, other MMEs 114, a Serving Gateway 116, and a Packet Data Network (PDN) Gateway 118. The MME 112 is the control node that processes the signaling between the UE 102 and the EPC 110. Generally, the MME 112 provides bearer and connection management. All user IP packets are transferred through the Serving Gateway 116, which itself is connected to the PDN Gateway 118. The PDN Gateway 118 provides UE IP address allocation as well as other functions. The PDN Gateway 118 is connected to the Operator's IP Services 122. The Operator's IP Services 122 may include the Internet, an intranet, an IP Multimedia Subsystem (IMS), and a PS Streaming Service (PSS).

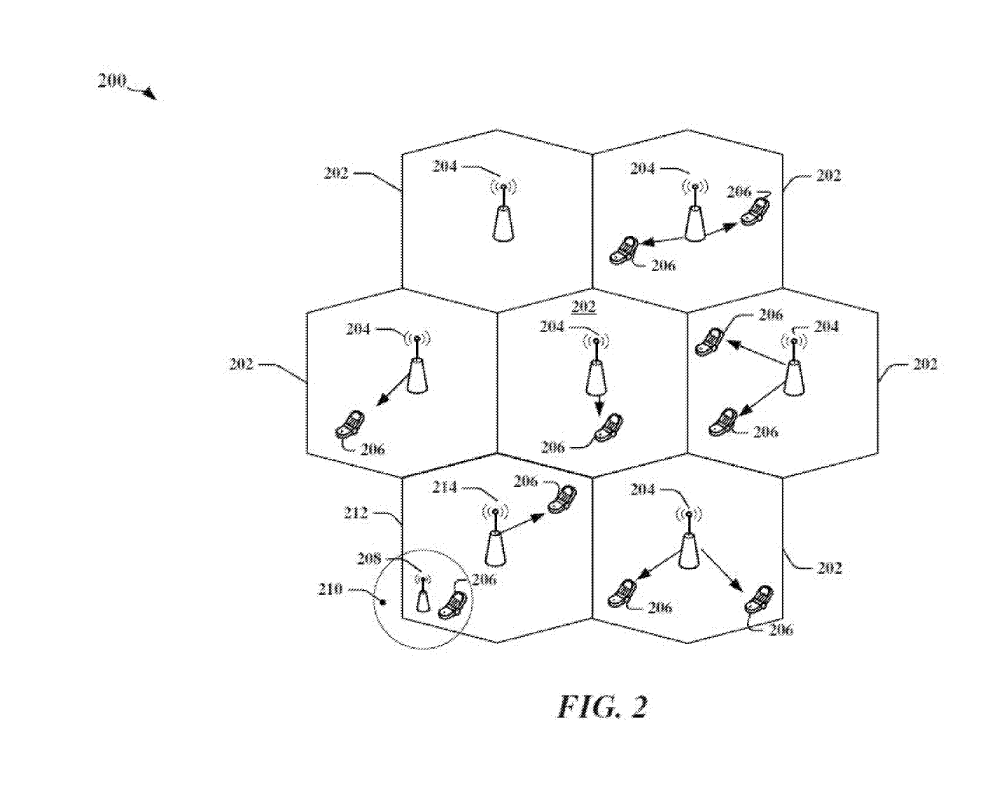

FIG. 2 is a diagram illustrating an example of an access network 200 in an LTE network architecture. In this example, the access network 200 is divided into a number of cellular regions (cells) 202, 212. One or more lower power class eNBs 208 may have cellular regions 210 that overlap with one or more of the cells 202, 212. The lower power class eNB 208 may be a femto cell (e.g., home eNB (HeNB)), pico cell, micro cell, or remote radio head (RRH). The macro eNBs 204, 214 are each assigned to a respective cell 202, 212 and are configured to provide an access point to the EPC 110 for all the UEs 206 in the cells 202, 212. There is no centralized controller in this example of an access network 200, but a centralized controller may be used in alternative configurations. The eNBs 204, 214 are responsible for all radio related functions including radio bearer control, admission control, mobility control, scheduling, security, and connectivity to the serving gateway 116.

The modulation and multiple access scheme employed by the access network 200 may vary depending on the particular telecommunications standard being deployed. In LTE applications, OFDM is used on the DL and SC-FDMA is used on the UL to support both frequency division duplexing (FDD) and time division duplexing (TDD). As those skilled in the art will readily appreciate from the detailed description to follow, the various concepts presented herein are well suited for LTE applications. However, these concepts may be readily extended to other telecommunication standards employing other modulation and multiple access techniques. By way of example, these concepts may be extended to Evolution-Data Optimized (EV-DO) or Ultra Mobile Broadband (UMB). EV-DO and UMB are air interface standards promulgated by the 3rd Generation Partnership Project 2 (3GPP2) as part of the CDMA2000 family of standards and employs CDMA to provide broadband Internet access to mobile stations, where an air interface may be defined as the radio-based communication link between a mobile station and an active base station.

These concepts may also be extended to Universal Terrestrial Radio Access (UTRA) employing Wideband-CDMA (W-CDMA) and other variants of CDMA, such as TD-SCDMA; Global System for Mobile Communications (GSM) employing TDMA; and Evolved UTRA (E-UTRA), IEEE 802.11 (Wi-Fi), IEEE 802.16 (WiMAX), IEEE 802.20, and Flash-OFDM employing OFDMA. UTRA, E-UTRA, UMTS, LTE and GSM are described in documents from the 3GPP organization. CDMA2000 and UMB are described in documents from the 3GPP2 organization. The actual wireless communication standard and the multiple access technology employed will depend on the specific application and the overall design constraints imposed on the system.

The eNBs 204, 214 may have multiple antennas supporting MIMO technology, and for 5G, the multiple antennas support massive MIMO technology. The use of MIMO technology enables the eNBs 204, 214 to exploit the spatial domain to support spatial multiplexing, beamforming, and transmit diversity. Spatial multiplexing may be used to transmit different streams of data simultaneously on the same frequency. The data steams may be transmitted to a single UE 206 to increase the data rate or to multiple UEs 206 to increase the overall system capacity. This is achieved by spatially precoding each data stream (i.e., applying a scaling of an amplitude and a phase) and then transmitting each spatially precoded stream through multiple transmit antennas on the DL. The spatially precoded data streams arrive at the UE(s) 206 with different spatial signatures, which enables each of the UE(s) 206 to recover the one or more data streams destined for that UE 206. On the UL, each UE 206 transmits a spatially precoded data stream, which enables the eNB 204, 214 to identify the source of each spatially precoded data stream.

Spatial multiplexing is generally used when channel conditions are good. When channel conditions are less favorable, beamforming may be used to focus the transmission energy in one or more directions. This may be achieved by spatially precoding the data for transmission through multiple antennas. To achieve good coverage at the edges of the cell, a single stream beamforming transmission may be used in combination with transmit diversity.

In the detailed description that follows, various aspects of an access network will be described with reference to a MIMO system supporting OFDM on the DL. OFDM is a spread-spectrum technique that modulates data over a number of subcarriers within an OFDM symbol. The subcarriers are spaced apart at precise frequencies. The spacing provides “orthogonality” that enables a receiver to recover the data from the subcarriers. In the time domain, a guard interval (e.g., cyclic prefix) may be added to each OFDM symbol to combat inter-OFDM-symbol interference. The UL may use SC-FDMA in the form of a DFT-spread OFDM signal to compensate for high peak-to-average power ratio (PAPR).

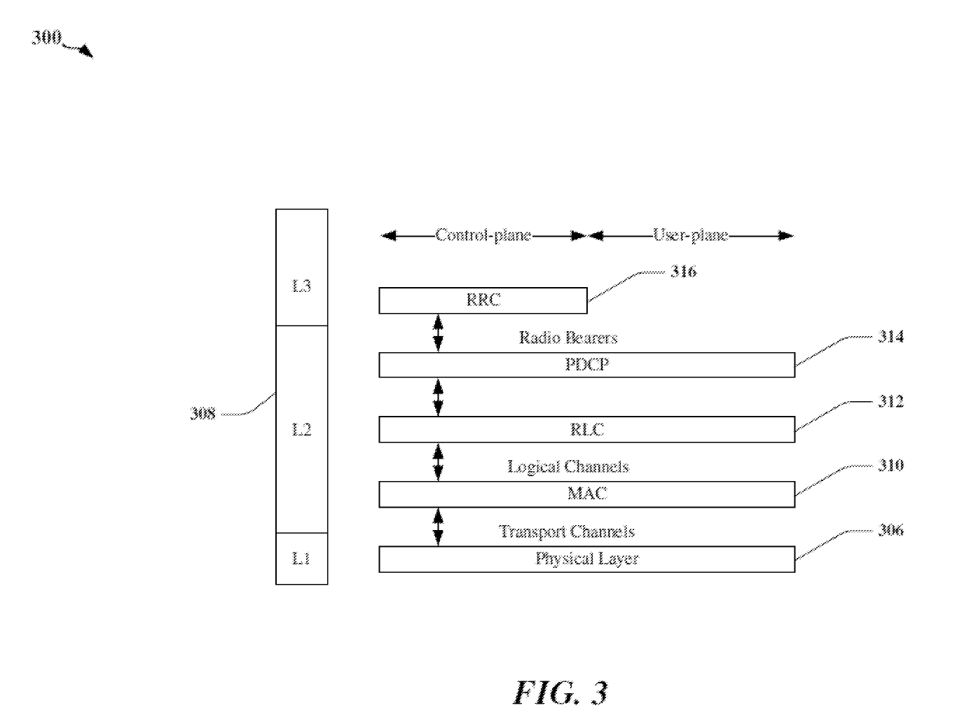

Networks, including packet-switched networks may be structured in multiple hierarchical protocol layers, where the lower protocol layers provide services to the upper layers and each layer is responsible for different tasks. FIG. 3 is a diagram illustrating an example of a radio protocol architecture 300 for the user and control planes (i.e., U-plane and C-plane) in an LTE implementation. The radio protocol architecture for the UE and the eNB is configured with three layers denoted as Layer 1, Layer 2, and Layer 3. Layer 1 (L1 layer) is the lowest layer and implements various physical layer signal processing functions. The L1 layer will be referred to herein as the physical layer or PHY layer 306. Layer 2 (L2 layer) 308 is above the physical layer 306 and is responsible for the link between the UE or eNB over the physical layer 306.

In the user plane, the L2 layer 308 includes a media access control (MAC) sublayer 310, a radio link control (RLC) sublayer 312, and a packet data convergence protocol (PDCP) 314 sublayer, which are terminated at the eNB on the network side. The PDCP sublayer 314 provides multiplexing between different radio bearers and logical channels. The PDCP sublayer 314 also provides header compression for upper layer data packets to reduce radio transmission overhead, security by ciphering the data packets, and handover support for UEs between eNBs. The RLC sublayer 312 provides segmentation and reassembly of upper layer data packets, retransmission of lost data packets, and reordering of data packets to compensate for out-of-order reception due to hybrid automatic repeat request (HARQ), dual connectivity operation, multi-connectivity operation or carrier aggregation operation. The MAC sublayer 310 provides multiplexing between logical and transport channels. The MAC sublayer 310 is also responsible for allocating the various radio resources (e.g., resource blocks) in one cell among the UEs. The MAC sublayer 310 is also responsible for HARQ operations.

In the control plane, the radio protocol architecture for the UE and eNB is essentially the same for the physical layer 306 and the L2 layer 308 with the exception that there is no header compression function for the control plane and there is an integrity-protection function in the PDCP sublayer 314 for the control plane. The control plane also includes a radio resource control (RRC) sublayer 316 in Layer 3 (L3 layer). The RRC sublayer 316 is responsible for obtaining radio resources (i.e., radio bearers) and for configuring the lower layers using RRC signaling between the eNB and the UE. Although not shown, the UE may have several upper layers above the L3 layer including a network layer (e.g., IP layer) that is terminated at the PDN gateway 118 on the network side, and an application layer that is terminated at the other end of the connection (e.g., far end UE, server, etc.).

Radio link setup by RLCs in an LTE network may involve establishment of one or more radio bearers (e.g., radio links or radio connections or one or more packet flows in radio connections) between two communication devices, such as an eNodeB and UE. A session bearer, which may be a logical bearer or logical channel, may then be established over the radio link and one or more services and/or conunmmunications may be established over the session bearer. It is noted here that although the term “radio bearer” is used in connection with RLC in LTE and other 4G technologies, it is to be understood that other terminology (e.g., a packet flow in a radio connection) may or could be used in 5G and later systems. Thus, an equivalent term could be “packet flow” in a radio connection or some other term to be understood to encompass various indications provided for each IP address, bearer, application of flow, and so forth; i.e., terminology used to describe and differentiate flows based on IP address.

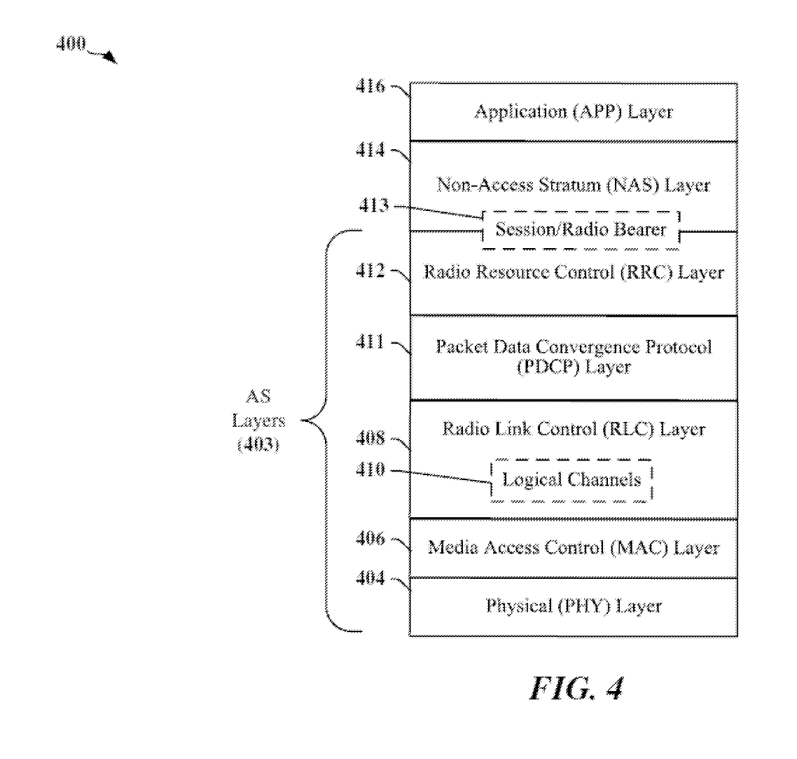

FIG. 4 illustrates an example of a protocol stack that may be implemented in a communication device operating in a LTE packet-switched network. In this example, the LTE protocol stack 400 includes a Physical (PHY) Layer 404, a Media Access Control (MAC) Layer 406, a Radio Link Control (RLC) Layer 408, a Packet Data Convergence Protocol (PDCP) Layer 411, an RRC Layer 412, a Non-Access Stratum (NAS) Layer 414, and an Application (APP) Layer 416. The layers below the NAS Layer 414 are often referred to as the Access Stratum (AS) 403.

The RLC Layer 408 may include one or more logical channels 410. The RRC Layer 412 may implement various monitoring modes for the user equipment, including connected state and idle state. The NAS Layer 414 may maintain the communication device's mobility management context, packet data context and/or its IP addresses. Note that other layers may be present in the protocol stack 400 (e.g., above, below, and/or in between the illustrated layers), but have been omitted for brevity and clarity. Radio/session bearers 413 may be established, for example, at the RRC Layer 412 and/or NAS Layer 414. Initially, communications to or from a communication device may be transmitted (unprotected or unencrypted) over an unsecured common control channel (CCCH). The NAS Layer 414 may be used by the communication device and an MME to generate security keys. After these security keys are established, communications including signaling and/or control messages may be transmitted over a Dedicated Control Channel (DCCH) and/or user data may be transmitted over a Dedicated Traffic Channel (DTCH). NAS context may be reused at the time of Service Request, Attach Request and Tracking Area Update (TAU) Request.

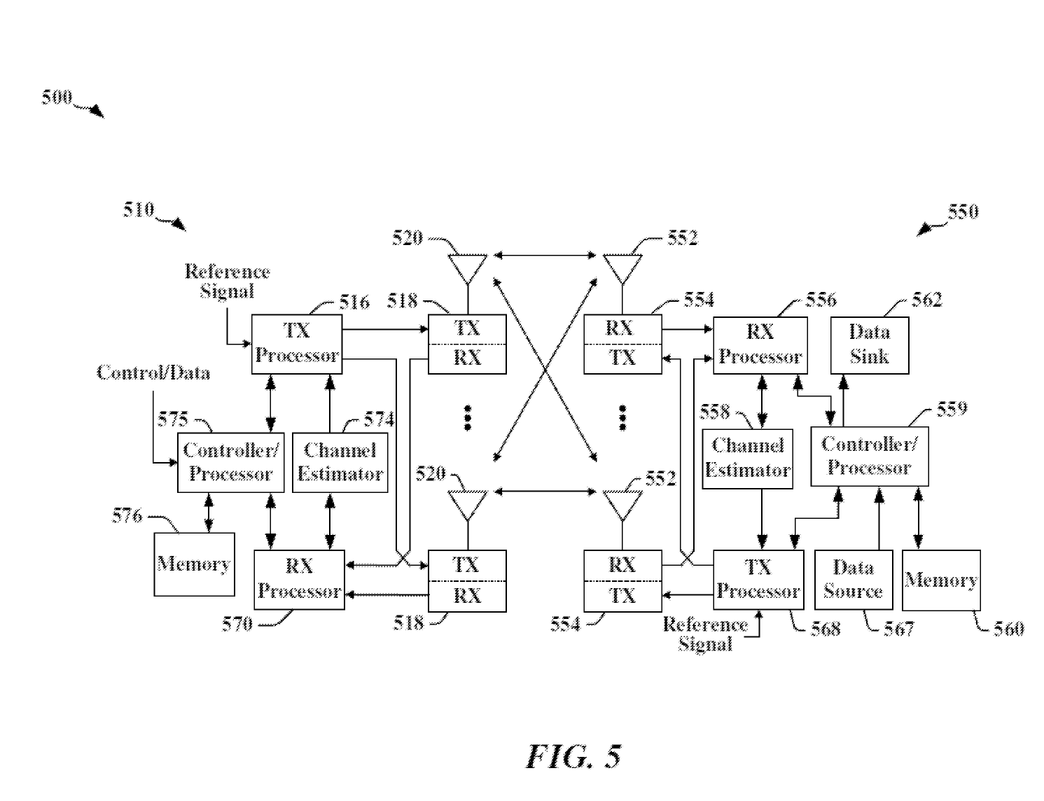

FIG. 5 is a block diagram 500 of an eNB 510 in communication with a UE 550 in an access network. The radio interface between the UE 550 and the eNodeB 510 may be referred to as the LTE-Uu. More generally, the term Uu may refer to the radio interface link between a UE and an eNodeB, including radio access technologies (RATs) other than 4G or LTE.

In the eNodeB 510 performing downlink or forward link communication to a UE, for example, upper layer packets from a core network containing control or data information are provided to a controller/processor 575. The controller/processor 575 implements the functionality of the L2 layer. Additionally, the controller/processor 575 provides header compression, ciphering, integrity protection, packet segmentation and reordering, multiplexing between logical and transport channels, and radio resource allocations to the UE 550 based on various priority metrics. The controller/processor 575 is also responsible for ARQ or HARQ operations, retransmission of lost packets, and signaling to the UE 550.

The transmit (TX) processor 516 implements various signal processing functions for the L1 layer (i.e., physical layer). The signal processing functions include coding and interleaving to facilitate forward error correction (FEC) at the UE 550 and modulation (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream is then mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream may be spatially precoded to produce multiple spatial streams. Channel estimates from a channel estimator 574 may be used to determine the coding and modulation scheme, as well as determine spatial processing. The channel estimate may be derived from a reference signal and/or channel condition feedback transmitted by the UE 550. Each spatial stream is then provided to a different antennas 520 via a separate transmitter of a TX/RX transceiver 518. Each transmitter in transceiver 518 modulates an RF carrier with a respective spatial stream for transmission.

At the UE 550, each receiver RX of a transceiver 554 receives a signal through respective antennas 552. Each receiver in transceiver 554 recovers information modulated onto an RF carrier and provides the information to a receive (RX) processor 556. The RX processor 556 implements various signal processing functions of the L1 layer. The RX processor 556 performs spatial processing on the information to recover any spatial streams destined for the UE 550. If multiple spatial streams are destined for the UE 550, they may be combined by the RX processor 556 into a single OFDM symbol stream. The RX processor 556 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the eNB 510. These soft decisions may be based on channel estimates computed by the channel estimator 558. The soft decisions are then decoded and deinterleaved to recover the data and control signals that were originally transmitted by the eNB 510 on the physical channel. The data and control signals are then provided to the controller/processor 559. The controller/processor 559 implements the L2 layer. The controller/processor can be associated with a memory 560 that stores program codes and data. The memory 560 may be referred to as a computer-readable medium. The controller/processor 559 provides demultiplexing between transport and logical channels, packet reassembly, deciphering, integrity check for the RRC signalling, header decompression, control signal processing to recover upper layer packets from the core network. The upper layer packets are then provided to a data sink 562, which represents all the protocol layers above the L2 layer. Various control signals may also be provided to the data sink 562 for L3 processing. The controller/processor 559 is also responsible for error detection using an acknowledgement (ACK) and/or negative acknowledgement (NACK) protocol to support ARQ or HARQ operations.

For uplink or reverse link communications, a data source 567 is used to provide upper layer packets to the controller/processor 559. The data source 567 represents all protocol layers above the L2 layer. Similar to the functionality described in connection with the DL transmission by the eNB 510, the controller/processor 559 implements the L2 layer for the user plane and the control plane by providing header compression, ciphering, packet segmentation and reordering, and multiplexing between logical and transport channels based on radio resource allocations by the eNB 510. The controller/processor 559 is also responsible for HARQ operations, retransmission of lost packets, and signaling to the eNB 510.

Channel estimates derived by a channel estimator 558 from a reference signal or feedback transmitted by the eNB 510 may be used by the TX processor 568 to select the appropriate coding and modulation schemes, and to facilitate spatial processing. The spatial streams generated by the TX processor 568 are provided to different antenna 552 via separate transmit portions in a transceiver 554. Each transmit portion may modulate an RF carrier with a respective spatial stream for transmission.

The uplink or reverse link transmissions from UE 550 to eNB 510 are received by receiver portions of transceiver 518 through respective antennas 520. Each receiver portion of the transceiver 518 recovers information modulated onto an RF carrier and provides the information to a RX processor 570. The RX processor 570 may implement the L1 layer. The controller/processor 575 may implement the L2 layer. The controller/processor 575 can be associated with a memory 576 that stores program codes and data. The memory 576 may be referred to as a computer-readable medium. For the received uplink transmissions, the control/processor 575 provides demultiplexing between transport and logical channels, packet reassembly, deciphering, integrity-check for the RRC signalling, header decompression, control signal processing to recover upper layer packets transmitted from the UE 550. Upper layer packets from the controller/processor 575 may be provided to the core network (not shown). The controller/processor 575 is also responsible for error detection using an ACK and/or NACK protocol to support HARQ operations. For the case of 5G, each antenna can also be one or more antennas and each RE chain can also be one or more RF chains.

With the advent of ubiquitous network access and the provision of wireless communications capabilities in ever-increasing numbers of mobile phones and/or computing devices, there is continuous demand for improved access to serving networks. In some access technologies, a heterogeneous network environment may support traditional large cells (macrocells) and small cells, where a small cell may be provided through low-powered radio access nodes that operate in licensed and unlicensed spectrum and that can have a range of between 10 meters and 2 kilometers. In some implementations of 4G 3GPP technologies, including LTE-Advanced for example, Relay Nodes (RNs) may include low power base stations that can be deployed to provide enhanced coverage and capacity at various locations in a cell, including at cell edges, and in hotspots. Referring again to FIG. 2, a relay node 208 may provide enhanced coverage in a small cell 210 that may be established within a large cell 212. The RN 208 may be connected to an eNB 214 (the Donor eNB (DeNB) 214) through a radio interface (Un), which may be a modified version of the E-UTRAN air interface Uu. The radio resources of the donor cell 212 may be shared between UEs 206 served directly by the DeNB 214 and the RN 208. The Uu and Un may use the same frequencies or different frequencies.

As mentioned before, for the radio link control (RLC) layer, a wireless device (e.g., an eNodeB or UE) operable according to WCDMA or LTE may be operated in one of three RLC data transfer modes or types of operation: transparent mode (TM), unacknowledged mode (UM), and acknowledged mode (AM). For TM data transfer, data is transferred transparently with nothing else offered. TM doesn't support any data segmentation or concatenation of RLC Service Data Units (SDUs) and so one RLC Protocol Data Unit (PDU) corresponds to one RLC SDU.

In UM data transfer is effected with some additional functionalities on top of TM, but doesn't offer automatic repeat request (ARQ) operation. At the transmitter side, UM supports data segmentation and concatenation of RLC SDUs. On the receiver side, UM supports duplicate avoidance, re-ordering, and reassembling RLC SDUs from the reordered UM data (UMDs). UM does not offer any data reception acknowledgement and retransmission.

For acknowledged mode (AM) data transfer, data transfer is performed with ARQ functionality on top of UM functionality. At the transmitter side, for example, AM supports data segmentation and concatenation of RLC SDUs and also supports retransmission of AM data (AMDs), which are negatively acknowledged by the receiver. At the receiver side, AM supports duplicate avoidance, re-ordering, and reassembling of RLC SDUs from the re-ordered AMDs and also supports AMD loss detection and retransmission request for the lost AMDs toward the peer RLC entity. For the ARQ operation, the receiver RLC entity sends a status report to the peer RLC entity (i.e., the entity to which data is being transmitted) so that the transmitter RLC entity can figure out which AMDs need to be retransmitted and which AMDs can be deleted from a TX buffer in the transmitter (e.g., the TX portion of transceiver 518). The periodicity of the status reporting may be controlled by counters with preconfigured thresholds for the counters corresponding to a predetermined time.

When a wireless device such as an eNodeB or UE, switches between an acknowledged mode (AM) of operation and an unacknowledged mode (UM) of operation, there are certain issues that may arise. In particular, when the device operates in AM, it provides for a radio bearer connection packet loss recovery and packet reordering at a protocol layer, such as the radio link control (RLC) layer. When the wireless device operates in UM, the device provides no packet loss recovery at the protocol layer for the radio bearer connection. The protocol layer can be one layer in a multi-layer protocol stack, the protocol layer being a radio link control (RLC) layer, a medium access control (MAC) layer, and/or a packet data convergence protocol (PDCP) layer. A first device may also be coupled to a second device via the radio bearer connection, and the individual mode of operation of one device may influence the mode of operation of the other device. In addition, the determination of whether to recover and/or reorder packet loss at the protocol layer can be performed at the RLC transmitting entity or a RLC receiving entity. RLC AM is normally configured for high speed data transfer because it offers (1) flow control and (2) automatic repeat request (ARQ) functionality, which in turn establishes reliable communications. However, RLC AM operation has drawbacks such as requiring a big data buffer for retransmissions, and allowing ARQ operation to degrade throughout due to delayed status reporting, for example. Delayed status reporting may occur due to, for example, a bad radio condition for the other direction of transmission flow, a bad configuration for status reporting, or a bad data scheduler implementation, which may not prioritize status reporting over user data.

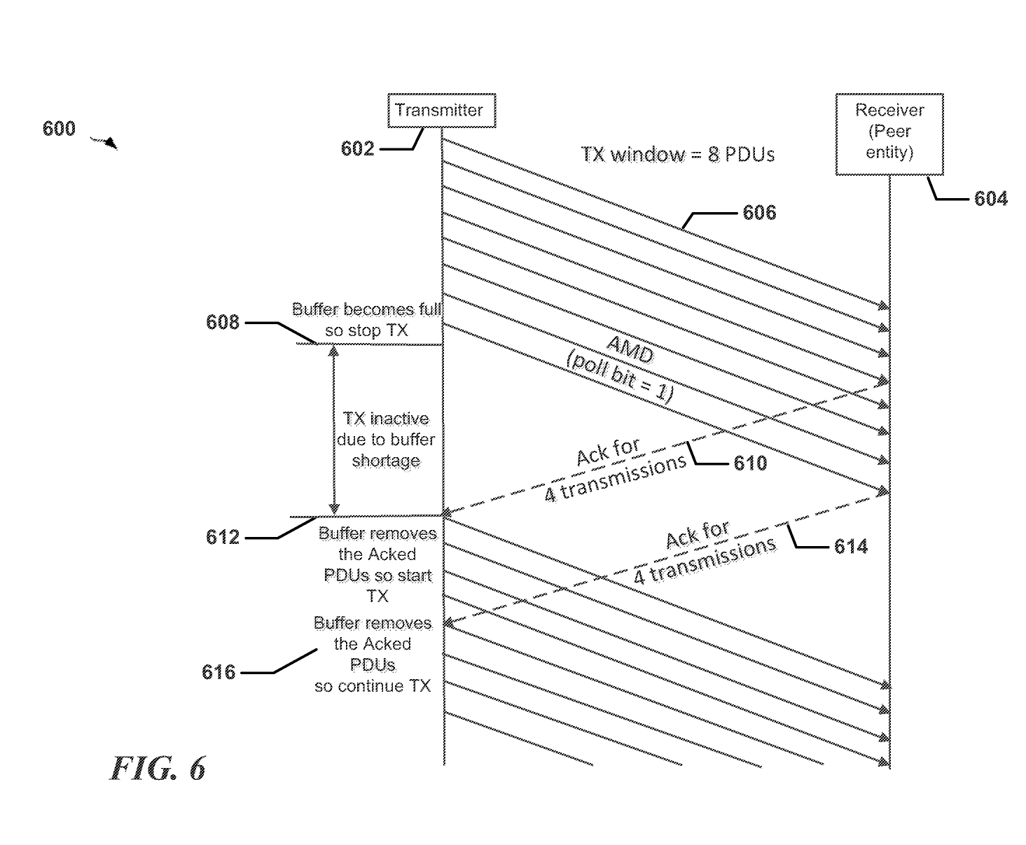

On the other hand, UM operation or RLC UM operation avoids the aforementioned problems. In fact, UM is used more often in real-life demonstration scenarios to test new features, because UM offers high speed throughout and allows the overall system in an exhibition to reach theoretical maximum throughput levels easier and faster when compared to AM. However, it may not be ideal to always operate in UM for data transfer because UM does not have ARQ functionality. That is, in UM operation, a missing data packet dropped due to a bad radio condition will not be recovered, which may impact the overall performance and reliability of the application. In an AM data transfer operation, a theoretical maximum throughput may be achieved only if the data transfer works well in both directions, data buffers at the transmit (TX) RLC and receiver (RX) RLC are large enough for the desired throughput, and the status reporting periodicity is ideally configured for the present radio condition and the buffer sizes. Otherwise the throughput will be degraded as will be discussed in connection with FIG. 6.

FIG. 6 illustrates a timing diagram 600 showing interactions between a transmitter 602 and a receiver 604 and further illustrating particular limitations of AM only operation. The transmission window, for the purposes of FIG. 6, is eight (8) AMD signals. Transmitter 602 transmits a series of eight AMD PDUs or signals 606 to the receiver 604. In this example, it is assumed that a poll bit is set to 1, where the poll bit (P) is used to indicate a request for status from (with a bit value of “1”) from a receiver or peer entity (i.e., receiver 604 in this example). When the receiver 604 receives a fourth AMD PDU transmitted by the transmitter 602, the receiver 604 transmits a first acknowledgment signal 610 back to the transmitter 602. Once the transmitter 602 has transmitted all eight AMD PDUs or signals at time or event 608, the buffer is full so transmission is stopped.

Furthermore, in response to the transmitter 602 transmitting all eight AMD PDU signals, the receiver 604 transmits a second acknowledgment signal 614. From event or time 608 to event or time 612, the transmitter 602 is inactive due to buffer shortage. At time or event 612, the buffer removes the acknowledged PDUs so that transmission can resume. Thus, at event 612, the transmitter 602 transmits four (4) more AMD signals. At event or time 616, when the transmitter 602 receives the second acknowledgment signal 614 from the receiver 604, the buffer removes the acknowledged PDUs from the buffer in order to continue transmission of a next group of 4 AMD signals. As may be seen by the gap between events 608 and 612, the throughput for transmitting eight AMD signals is degraded because the buffer removes the acknowledged PDUs when only after four AMD PDUs or signals have been transmitted and acknowledged Therefore, the overall scheme of FIG. 6 is not operating as efficiently as it can, due to the limitations of a strictly AM data transfer operation.

Accordingly, in order reduce degradation of the throughput for the various RLC modes, the present disclosure provides new RLC mode switch methods and apparatus that operate in at least two different ways to provide smart RLC mode switching schemes. A first approach is to perform dynamic switching where the RLC entity switches the RLC mode of a device between AM and UM modes. A second approach is to define a new combined AM/UM mode that enables a transmitter to flush the receiver buffer using bits or flags. Once the new combined AM/UM mode is configured for the second approach, the RLC header in RLC packets is enhanced to allow both an AM and UM mode of operation to switch per transmitted RLC packet. The device also allows continued status reporting even in the UM operation mode so that the transmitting RLC in the peer RLC entity can measure the packet error rate (PER) and/or packet latency. [Note to inventors—Is the dynamism of the first approach engendered by providing schema allowing the RLC entity itself to control the AM/UM switching as well as further being able to request/signal a peer RLC to also switch modes?Leaving aside the particular details of how you are measuring, triggering, changing, and signaling the mode switch through fields/bits in the PDUs, from a big picture conceptual standpoint, does the ability to allow the RLC entity to determine when to trigger the switch offer any benefits that are significantly different from the prior art switching between AM/UM?Did the prior art not provide any means by which the RLC entity could determine when to switch between AM/UM and request a peer to do so as well?Also, could the dynamism be enhanced due to your ability on an per PDU basis to signal a mode switch with your various PDU header schemes/bit values?]

There are a number of advantages brought about by the disclosed approaches. For example, large data buffers for data retransmission at the transmitter and for data concatenation at the receiver are no longer necessary. Instead, the size of the data buffers may be reduced for the retransmission or concatenation for slow throughput operations. In addition, for high speed operation, no flow control is applied (i.e., UM is utilized) and thus the system can easily achieve high throughput without any RLC parameter fine-tuning. High throughput can also be achieved without compromising reliability in bad radio conditions, because the RLC entities still perform ARQ procedures while in low speed operation (e.g., due to bad radio conditions).

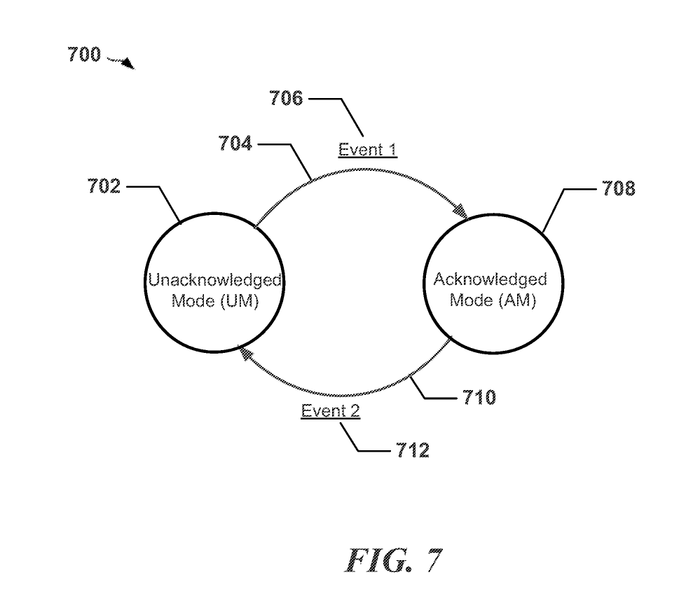

FIG. 7 is a state diagram 700 illustrating switching between AM and UM modes according to the present disclosure. illustrates a state diagram 600 that includes an unacknowledged mode state 702, a first event switch 704, a first event 706, an acknowledge mode state 708, a second event switch 710, and a second event 712. The first event 706 triggers the first event switch 704 to move the state from UM state 702 to AM state 708, and the second event 712 triggers the second event switch 710 from AM state 708 to UM state 702.

The dynamic switching procedure illustrated in FIG. 7 may be executed through the use of various procedures including measuring performance, determining an event trigger based at least one the measured performance, and then following a mode switch procedure.

Concerning performance measurement, in one aspect a receiving RLC entity may measure the receive throughput or a data packet (e.g., PDU) drop rate or packet error rate (PER) as metrics for measuring. In another aspect, the transmitting RLC entity may measure transmit throughput, a rate of data packet (e.g., PDU) retransmission, a rate of negative acknowledged PDUs (e.g., packet error rate (PER)), or packet latency, such as the latency between the RLC entities or a measured end-to-end latency. Latency between the RLC entities is the time delay between a first RLC and a second peer RLC. End-to-end latency is a latency between the peer ends of two devices. For example, the end-to-end latency is between a first peer end of a first device (e.g., a mobile device's web browser) and a second peer end of a second device (e.g., a hypertext transfer protocol (http) server). In one implementation, the application layers of the two peer ends of two different devices may be present. In another implementation, the application layers of two different devices may also be different, or an application layer may simply not exist in one device, or both devices. For example, if the first device is a mobile device and the second device is a network access node, such as an eNB (evolved Node B, Node B or base station), then an application layer exists only in the mobile phone device itself, not in the network access node. In the case of the network access node, the application layer is located in the server of the internet and not in the network access node itself. A user-plane measurement can also be taken, the user-plane measurement including a data rate, a buffer size, a PER, and/or block error rate (BLER). Other measurement objects can include the end-to-end round trip time (RTT) as measured by transmission control protocol (TCP), and the number of flows currently active over the radio bearer connection for the case that a packet for one flow that is lost holds up the traffic for all the other flows being forwarded to the higher layers. Furthermore, to perform the measurement of PER or latency at the transmitting RLC, the transmitting RLC would receive continual status reporting from a peer RLC entity, even in UM operation.

If the measured result (e.g., throughput, PER, or latency) fulfills certain criteria, which may be a logical conditions set for the first event 706 or the second event 712, the RLC entity requests or indicates to the peer RLC entity to switch the RLC mode. An RLC entity evaluates the measured result, called “X,” according to certain predetermined criteria. For example, the certain criteria for the measured result X may be according to the following inequality relationships:

Inequality1:X−Hysteresis>Threshold (1)

Inequality2:X+Hysteresis<Threshold (2)

where the Threshold is a predetermined threshold based on either known standards or empirically determined conditions, and Hysteresis is some value or amount configured to introduce hysteresis in the determinations in order to prevent too frequent switching or ping-ponging between the AM and UM modes.

The particular values or objects being measured affect which of the inequalities in equations (1) and (2) above triggers the RLC switch from UM to AM or vice versa. For example, if the measurement object is throughput, then Inequality 1 would trigger the RLC switch from AM to UM (i.e., akin to Event 1 (706) in FIG. 7), and Inequality 2 would trigger the switch from UM to AM (i.e., akin to Event 2 (712) in FIG. 7). On the other hand, if the measurement object is PER, for example, then Inequality 1 would trigger the RLC switch from UM to AM (i.e., akin to Event 2 (712) in FIG. 7), and Inequality 2 would trigger the switch from AM to UM (i.e., akin to Event 1 (706) in FIG. 7).

When an RLC entity decides to trigger RLC mode switching as determined by the application of the criteria above, an RLC mode switch procedure is initiated. This procedure includes an originating RLC entity sending a request signal to a peer RLC entity to start operating according to the other mode (e.g., from AM to UM, or from UM to AM). When the peer RLC entity receives this request signal, the peer RLC entity acknowledges successful receipt of the request signal back to the originating RLC entity, such as through transmission of an acknowledgment signal or message (e.g., an ACK message). After the originating RLC entity receives the acknowledgement message, the originating RLC entity begins operating according to the new mode.

It is noted that according to an aspect, when the transmitting or originating RLC entity measures packet error rate (PER) or packet latency in this mode switch procedure, the peer RLC entity may perform continual status reporting to the transmitting RLC even in the UM operation mode. It is also noted that in this procedure of sending a mode switch request and receiving an acknowledgment back, it is possible that the peer RLC entity may deny the request for mode switch by sending back a non-acknowledgment message (e.g., a NACK message).

According to another aspect, measures may be taken to try to ensure successful RLC mode switch signaling in the above-described procedures. In particular, additional timers or counters may be employed. For example, one solution is a timer to measure the time elapsing from the sending of the request to the receipt of the acknowledgment in the originating RLC entity may employed (e.g., this could be termed “t-ModeSwitch”). Thus, this timer may be used to determine if receipt of the acknowledgement is taking too long and take appropriate action should the acknowledgment be delayed too long. For example, the timer would be stopped when the RLC mode switch ACK signal is received from the peer entity within an acceptable predetermined time limit. On the other hand, if the timer expires, then the RLC entity could retransmit the RLC mode switch request to the peer entity.

Another solution would be to further employ a counter that counts the number of mode switch requests (e.g., termed “number_of_MS). If the number of unsuccessful mode switch requests meets or exceeds a predetermined number or maximum limit, which would be incremented (or decremented from a predetermined value toward zero) after each unsuccessful request (as determined after expiration of the t-ModeSwitch timer, for example). If the number of mode switch requests reaches the maximum limit, the main RLC entity may report this error to an upper layer so that the upper layer can take a necessary action, such as a radio bearer release or a call re-establishment, as examples.

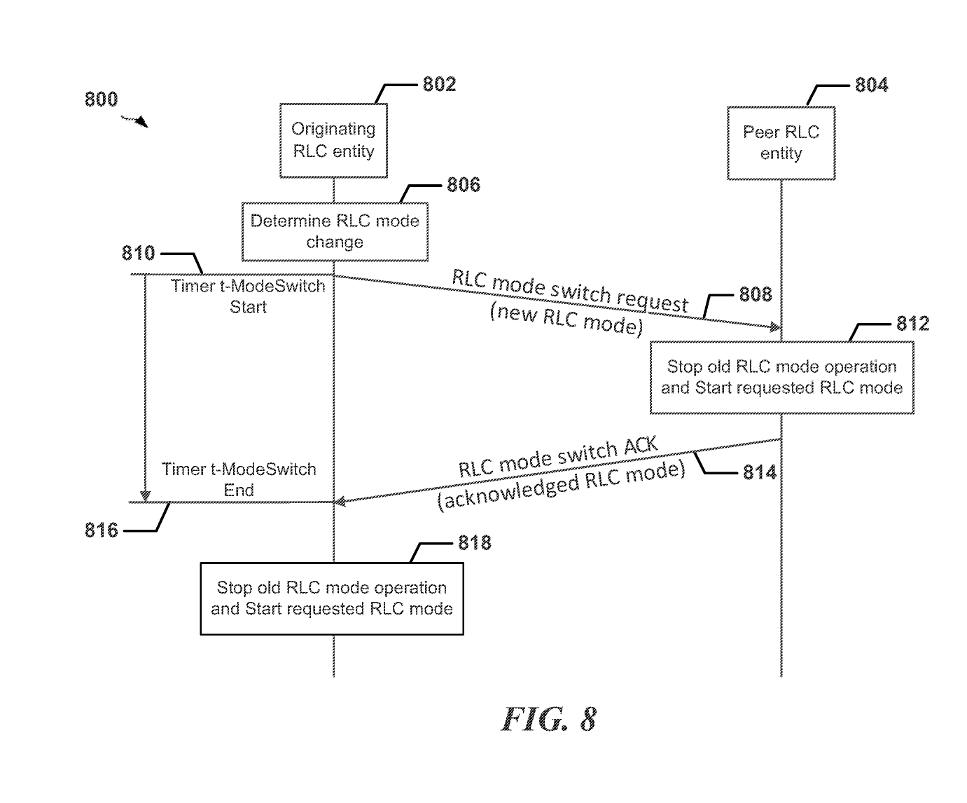

FIG. 8 illustrates a timing diagram 800 showing interactions between an originating RLC entity 802 and a peer RLC entity 804. The main RLC entity 802 determines whether to change the current RLC mode at time or event 806. An RLC mode switch request 808 bearing information on the new RLC mode to switch to is sent from the originating RLC entity 802 to the peer RLC entity 804. In an aspect, the sending of the request 808 may also start a timer (e.g., the disclosed “t-ModeSwitch”) at time or event 810.

When the peer RLC entity 804 receives the RLC mode switch request 808 (and assuming that peer 804 abides by the request 808), the peer RLC entity 804 stops the old RLC mode operation and starts the requested RLC mode operation (e.g., switching from AM to UM). The peer RLC entity 804 then also transmits an RLC mode switch acknowledgment ACK 814 to the originating RLC entity 802. Upon receipt of the ACK signal 814, the originating RLC entity may stop the t-ModeSwitch timer, as illustrated at time or event 816, should this aspect be utilized in the system. In an aspect, if the ACK 814 is not received (or, alternatively, a NACK signal is sent by peer entity 804), the timer t-ModeSwitch may time out and retransmission of the mode switch request 808 may be made. In another aspect, the counter discussed above may also be utilized to count the number of times a mode switch request 808 is sent to the peer RLC entity 804, with appropriate action being taken when a maximum limit for this counter is reached. Irrespective of whether or not the t-ModeSwitch timer is used, when the originating RLC entity 802 receives the ACK signal 814 from peer entity 804, entity 802 will stop its old RLC mode operation and start operating according to the RLC mode determined at event 806 as indicated by event or time 818.

According to further aspects, and as alluded to above, the peer RLC entity 804 can deny the RLC mode switch request 808 by sending back an acknowledgment message with negative acknowledgment (NACK) information in the RLC mode switch acknowledgment 814. Alternatively, instead of using a positive acknowledgment message (ACK) or a negative acknowledgement message (NACK) to grant or deny the RLC mode switch request 808, a mode switch request acknowledgment message may be used to grant the RLC mode switch request and a mode switch request failure message may be used to deny the RLC mode switch request. Additionally in other aspects, the RLC mode switch request 808 and/or the RLC mode switch acknowledgment 814 may be sent within a radio link control (RLC) layer status protocol data unit (PDU), a radio resource control (RRC) message, a bit in a radio link control (RLC) layer PDU, a packet data convergence protocol (PDCP) status PDU, a bit in a PDCP data PDU, a medium access control (MAC) control element, or a bit in a MAC PDU.

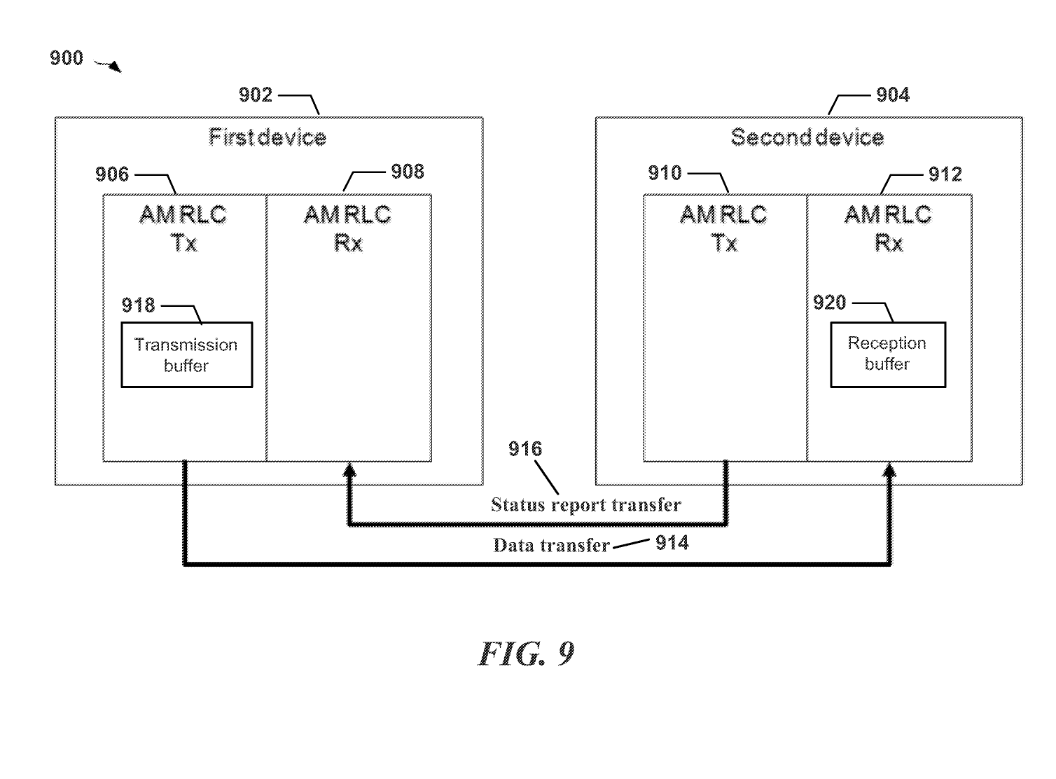

FIG. 9 illustrates a diagram 900 showing the data transfer and reception flows between a first device 902 and a second device 904 (e.g., first and second devices having respective RLC entities). The first device 902 includes a first acknowledged mode (AM) radio link control (RLC) transmission unit 906, and a first AM RLC reception unit 908. The second device 904 includes a second AM RLC transmission unit 910 and a second AM RLC reception unit 912. A device data transfer 914 flows from the first AM RLC transmission unit 906 to the second AM RLC reception unit 912. A status report transfer 916 flows from the second AM RLC transmission unit 910 to the first AM RLC reception unit 908. The first device 902 and/or the second device 904 can be a mobile device, or a network access node (an eNB), or different RLC entities such as the originating RLC entity 802 and the peer RLC entity 804 shown in FIG. 8. In the device data transfer 914, the first AM RLC transmission unit 906 sends data to the second AM RLC reception unit 912, which may include indications on which operation mode for the first device or second device to adopt, setting adjustments, performance data, and so on. In the status report transfer 916, the second AM RLC transmission unit 910 transmits to the first AM RLC reception unit 908 information such as status reports, which acknowledge the initial data reception sent in the device data transfer 914, or other acknowledgment data.

As one skilled in the art will appreciate, the present disclosure may be envisioned to encompass at least two types of RLC mode switching. The first type is a type of “bi-directional” mode switching, where both originating and peer entities switch RLC modes, such as in the example of FIG. 8. The second type could be a type of “uni-directional” mode switching, where either an uplink or a downlink between the RLC entities is changed. In this case, even if a receiving side of an RLC entity decides to switch modes, the transmitting side of the RLC entity may continue operation according to the old RLC mode operation (e.g., for downlink, the AM mode is in operation while a UM-like mode is in operation for the uplink, or vice-versa).

FIG. 9 may be shown to support the uni-directional mode switch where the first AM RLC transmission unit 906 (operating in AM mode) transmits data to the second AM RLC receiver unit 912 (also operating in AM mode), except that the second AM RLC transmission unit 910 is now a second UM RLC transmission unit 910 (operating in UM mode) that acknowledges the data reception of the above-mentioned data transaction, and generates and transmits status reports reflecting that data reception to the now first UM RLC reception unit 908 (also operating in UM mode), which was formerly the first AM RLC reception unit 908.

Moreover, FIG. 9 also illustrates that both the RLC transmit 906 in the first device may include a transmission buffer 918 that buffers the PDUs for AM operation. Correlatively, on the receiver side of data transfer 914, the receiver RLC includes a reception buffer 920 that buffers incoming PDUs. Although not shown, the transmit and receive units 910 and 908 may also include respective transmission and receive buffers.

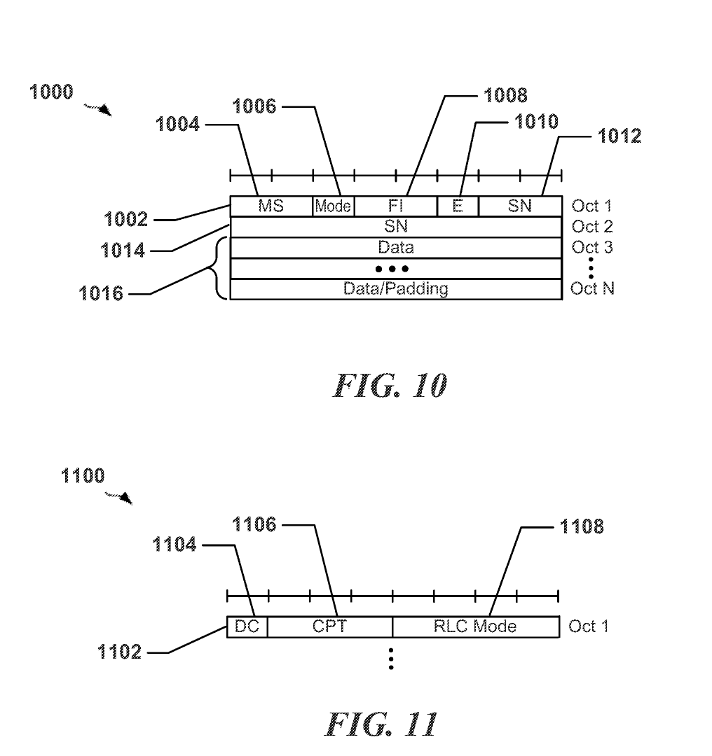

Furthermore, it is noted that there are at least a couple of ways to signal the RLC mode switch request 808 and the RLC mode switch acknowledgment 814 shown in FIG. 8. In an aspect, the signaling accomplished by signals 808 and 814 may be effected using either in-band signaling in a Data PDU or status PDU signaling. In furtherance of describing this concept, FIG. 10 illustrates an exemplary RLC Data PDU construction that may be used to implement in-band signaling of the signals 808 or 814. With in-band signaling, the RLC mode switch commands are signaled by RLC data protocol data units (PDUs). To this end, the present disclosure provides for a new field within the RLC Data PDU header. In particular, this field defines a mode switch request or acknowledgment field that is used to signal the RLC mode switch request 808, for example, with the new RLC mode information, or the RLC mode switch acknowledgment 814 in the other direction. As may be seen in FIG. 10, an RLC Data PDU 1000 is formatted with an N number of octets of 8 bits each (i.e. a byte). It is noted that a RLC PDU is a bit string with an N multiple of 8 bits or octets in length, and the representation of this bit string in FIG. 10 is illustrated in a table form.

The first octet 1002 (i.e., Oct 1) includes header information having a number of bit fields in the octet. A first field 1004 of two bits in octet 1002 is the introduced signaling of the mode switch (MS) request (or acknowledgement field in the case of the acknowledgement from the peer to the originating RLC entity). Another field 1006 contain is a mode signal field that indicates whether the particular mode, such as AM or UM. The first octet 1002 may also include a framing information (FT) field 1008 used for indicating the relative location of this particular RLC data PDU with respect to or within higher level data organization such as service data units (SDUs). Octet 1002 also includes an extension bit field (E) 1010 that indicates whether the particular RLC data PDU 1000 has an extension bit and whether user data follows immediately after the RLC header or if a length indicator (not shown) is present after the RLC header, and a sequence number (SN) field 1012 indicating where the PDU falls in a sequence of PDUs. As the sequence number (SN) may typically be more than two bits, the second octet 1014 continues the SN. Finally, the data of the PDU is contained in the remaining N number of octets 1016. It is noted that although FIG. 10 illustrates the various fields in PDU 1000 having a particular number of bits in each field, the field lengths are not necessarily limited to such should signaling require more or less bits as desired in future implementations.

Concerning the contemplated second way to signal the RLC mode switch request 808 and the RLC mode switch acknowledgment 814 shown in FIG. 8, the signaling may also be accomplished with an RLC Status PDU. FIG. 11 illustrates an exemplary Status PDU 1100 that is used for such signaling. The Status PDU 1100 is shown with three fields in the first octet 1102 of the PDU 1100. The first field 1106 is the D/C bit, which indicates whether the PDU is a Data or Control PDU. For this PDU, the bit will be a value (typically “0”) indicating that the PDU 1100 is a Control PDU, of which a Status PDU is one type of Control PDU. The next field is a Control PDU Type (CPT) field 1108 that is used in the present example to further signal the RLC mode switch commands (e.g., request 808 or ACK 814). Specifically, at least two CPT values are defined according to the present example for the respective RLC mode switch request (e.g., 808), and the RLC mode switch ACK (e.g., 814). When the bits of the CPT field 1108 are set to indicate the request from an originating entity to a peer entity (e.g., request 808), for example, then an RLC mode field 1108 will include bit indicating what RLC mode (e.g., AM or UM) would be used after the RLC mode switch. In the other direction (e.g., ACK 814), the value of the CPT field 1108 would be set to indicate the RLC mode switch is acknowledged (and the RLC mode field is not necessarily needed, but could be indicated back as further acknowledgement in an aspect).

Concerning the procedures or mechanisms for effectuating the RLC mode switching within the RLC entities (e.g., 802 and 804, or 902 and 904), one skilled in the art will appreciate that the mode switching will involve resetting one or more of state variables, counters, and timers set for the old RLC mode when switching to the new RLC mode.

Regarding entities operating in acknowledged mode (AM), such RLC entities have a number of state variables, counters and timers at least in LTE systems that will be affected. It is noted that presently disclosed methods and apparatus are applicable to 5G technologies and later, and most likely similar variables, counters and timers will be defined in such systems. Thus, the switching procedures that would be implemented in 5G would involve resetting correlative functioning state variables, counters, and timers.

With regard to LTE, in one example, affected state variables on the transmitting side of an AM RLC entity, as defined in the 3GPP specification, include variables VT(A), VT(MS), and VT(S), where VT(A) represents the acknowledgment state variable, VT(MS) represents the maximum send state variable, and VT(S) is the send state variable. Variables affected on the receiving side of AM RLC entity include state variables: VR(R), which is the receive state variable, VR(MR), which is the maximum acceptable receive state variable, VR(X), which is the T_reordering state variable, VR(MS), which is the maximum STATUS transmit state variable, and VR(H), which is the highest expected state variable. Additionally, counters affected on the transmitting AM RLC entity may include POLL_SN, which is the poll send state variable, PDU_WITHOUT_POLL, which is the counter used for t-StatusProhibit, BYTE WITHOUT_POLL, which is the counter used with t-StatusProhibit, and RETX_COUNT, which is the counter of the number of retransmissions.

Further, timers affected in the transmitting AM RLC entity include a t-PollRetransmit, which is a timer used by the transmitting side of an AM RLC entity to retransmit a poll bit. On the receiving side, timers for a peer AM RLC entity affected include a t-Reordering timer, which is a timer used by a receiving side AM RLC entity and receiving UM RLC entity to detect loss of RLC PDUs at a lower layer, and a t-SiatusProhibit timer, which is a timer used by the receiving side of an AM RLC entity for prohibiting transmission of a status PDU.

Therefore, when a mode change operation is executed, the transmitting side of the AM RLC entity resets all the state variables and the counters, and stops the transmitting side timer. The receiving side of the AM RLC entity resets all the state variables and stops the timers. If the t-Reordering timer is running upon the mode change, the receiving side of the AM RLC entity stops the reordering operation and immediately assembles RLC SDUs from the re-ordered RLC PDUs and delivers the RLC SDUs while discarding the remaining acknowledged mode data (AMD), which could not be assembled into RLC SDUs. However, the above may be impacted for status reporting during UM operation. As an example, for the transmitting RLC to measure packet error rate (PER) or latency in this status PDU signaling procedure, the peer RLC entity should perform continual status reporting to the transmitting RLC even in the UM operation mode.

Regarding entities operating in unacknowledged mode (UM), such RLC entities also have a number of state variables, counters and timers at least in LTE systems that will be affected. It is also noted again that the presently disclosed methods and apparatus are applicable to 5G technologies and later, and most likely similar variables, counters and timers will be defined in such systems. Thus, the switching procedures that would be implemented in 5G would involve resetting correlative functioning state variables, counters, and timers.

UM RLC entities, on the transmitting side, maintain a number of state variables that will be reset. These variables, as defined in the 3GPP specifications for LTE, include VT(US), which is a state variable that holds the value of the sequence number (SN) to be assigned for the next newly generated UMD PDU. This variable is usually set to 0, initially. and is updated whenever the UM RLC entity delivers an UMD PDU with SN=VT(US). On the receiving side, a UM RLC entity's state variables maintains at least the state variables VR(UR), which is the UM receive state variable, VR(UX), which is the UM t-Reordering state variable, and VR(UH), which is the UM highest received state variable. Concerning times, the receiving side UM RLC entity includes timer t-Reordering, which is a timer used by the receiving side of an AM RLC entity and receiving UM RLC entity to detect loss of RLC PDUs at a lower layer. Upon mode change, the transmitting side of the UM RLC entity will reset all the state variables and the receiving side of the UM RLC entity will reset all the state variables and stops the timer t-Reordering. If the t-Reordering timer is running upon the mode change, the receiving side of the UM RLC entity stops the reordering operation and immediately assembles RLC SDUs from the re-ordered RLC PDUs and delivers the RLC SDUs while discarding the remaining acknowledged mode data (AMD), which could not be assembled into RLC SDUs. The transmitter side of the RLC entity and the receiving side of the RLC entity start the new RLC mode operation after the initialization procedure discussed earlier in connection with FIG. 8.

The previous disclosure concerning FIGS. 8-11 discussed exemplary methods and apparatus for dynamically switching between AM and UM for RLC entities in order to better optimize performance. Another exemplary approach, as mentioned before, is to utilize a combined AM/UM mode of RLC where the transmitting or originating side of the RLC entity indicates the transmitter state in a RLC data PDU and the receiving side of the peer RLC entity handles the RLC data PDU according to the combination of a poll bit (P) and a buffer bit (B) in the header of an RLC PDU.

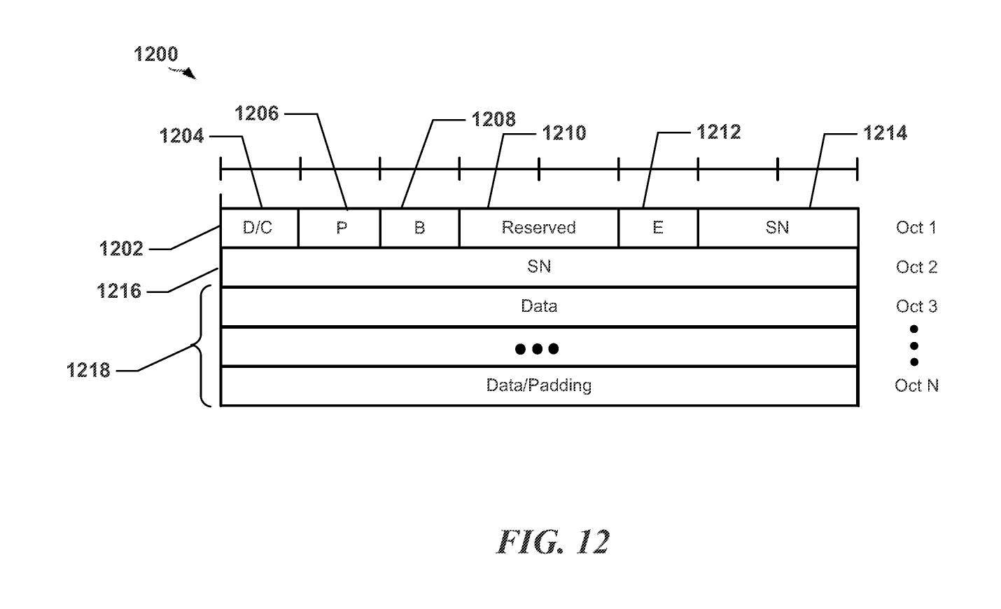

FIG. 12 illustrates an exemplary RLC PDU structure 1200 that is used to effectuate the combined AM/UM mode according to the present disclosure. PDU 1200 features header data in the first octet 1202 including a data/control (D/C) bit field 1204, a poll bit (P) field 1206, a buffer bit (B) field 1208, a reserved bit field 1210, an extension bit (E) field 1212, and a sequence number (SN) field 1214. As discussed before, a D/C bit 1204 indicates whether the RLC PDU 904 is for RLC control signaling (e.g., a status PDU) or data. The poll bit (P) field 1206 represents the RLC poll bit (P) and signals whether the transmitter requests the receiver to send a status report or not. The buffer bit (B) field 1208 represents the RLC buffer bit (B) and signals how the RLC data PDU should be handled with regard to buffering of the PDUs. The reserved field 1210 is reserved bits for the RLC data PDU 1200. The extension bit (E) field 1212 indicates whether user data follows immediately after the RLC header or if a length indicator (LI) is present after the RLC header. The sequence number field 1214 indicates the RLC sequence number (SN) associated with the current RLC data PDU and where the PDU falls in a sequence of PDUs. As the sequence number (SN) may typically be more than two bits, the second octet 1216 continues the SN within the header information. Finally, the data of the PDU is contained in the remaining N number of octets 1218. It is noted that although FIG. 12 illustrates the various fields in PDU 1200 having a particular number of bits in each field, the field lengths are not necessarily limited to such should signaling require more or less bits as desired in future implementations.

As discussed before, an originating RLC entity indicates the transmitter state in a RLC data PDU, such as PDU 1200, and the receiving side of the peer RLC entity handles the RLC data PDU according to the combination of a poll bit (P) 1206 and a buffer bit (B) 1208 located in the header of an RLC PDU. Upon receipt of these bit values, the receiver or peer RLC entity may act in one of four ways as there are two bits (i.e., the P and B bits) communicating four different states. These particular actions are illustrated in Table 1 below.

TABLE 1

| Poll | Buffer | |
|---|---|---|
| bit | bit | Receiver action |
| 0 | 1 | Buffer the received RLC data and forward, in order, to |
| | | the higher layers. |
| | | Indicate to the transmitter the RLC PDU status when the |
| | | receiving side detects any missing RLC Data PDUs and |
| | | the t-Reordering (AM) timer expires. |
| 1 | 1 | Buffer the received RLC data and forward, in order, to |
| | | the higher layers. |
| | | Indicate to the transmitter the RLC PDU status. |
| 0 | 0 | Forward received data to the higher layers. No buffering |
| | | is performed to enable RLC recovery of missed packets |
| | | and the in-order delivery to the higher layers. |
| | | Optionally an RLC PDU status is transmitted when the |
| | | receiving side detects any missing RLC Data PDUs and |
| | | the t-Reordering (UM) timer expires. |
| 1 | 0 | Forward received data to the higher layers. No buffering |
| | | is performed to enable RLC recovery of missed packets |
| | | and the in-order delivery to the higher layers. |
| | | Indicate to the transmitter the RLC PDU status. |

The first two rows of Table 1 essentially define existing AM behavior typically found at a receiver RLC entity. In particular, the first row of Table 1 shows that if the P bit is zero (P=0), indicating no status request, and the B bit is one (B=1), indicating buffering, then the received RLC data will be buffered at the receiver and forwarded, in order, to the higher layers in the receiving entity. Additionally, the receiving RLC entity will indicate to the transmitter the RLC PDU status when the receiving side detects any missing RLC Data PDUs and the t-Reordering (AM) timer expires. In the case shown in the second row of Table 1, the P=1, indicating a status request, and B=1, indicating buffering. In this situation, the receiver responds by first buffering the received RLC data and forwarding the data, in order, to the higher layers. In this situation, since P=1, the receiver also indicates the RLC PDU status to the transmitter.

The last two rows of Table 1 define a UM mode behavior at the receiver, but with additional information or modifications over normal UM mode. In particular, the third row of Table 1, where P=0 and B=0, includes forwarding received data to the higher layers, where no buffering is performed to enable RLC recovery of missed packets and in-order delivery to the higher layers. In this case, it is left to the higher layers to re-order the packets. In addition, the present disclosure ascribes a new behavior to the values P=0 and B=0 where the receiver can optionally report the RLC PDU status when any missing RLC data PDU is detected, and the t-Reordering (UM) timer expires.

The fourth row of Table 1, shows that where P=1, B=0, received data is forwarded to the higher layers at the receiver entity. Additionally, no buffering is performed to enable RLC recovery of missed packets and in-order delivery to the higher layers. In this case, it is left to the higher layers to re-order the packets. The present disclosure also defines a new behavior ascribed to these values where the RLC receiver entity indicates the RLC PDU status to the transmitter entity. Thus, the RLC transmitter can optionally poll the RLC receiver and retransmit the missing packets.

An assumption to the above processes in Table 1 may be that the UE still performs re-ordering with a short duration to absorb out-of-order delivery due to HARQ, dual/multi-connectivity and/or carrier aggregation (CA) operations. Furthermore, for the transmitting RLC to measure packet error rate (PER) or latency in this combined AM/UM mode using buffer and poll bits, the peer RLC entity should perform continual status reporting to the transmitting RLC even in the UM operation mode.

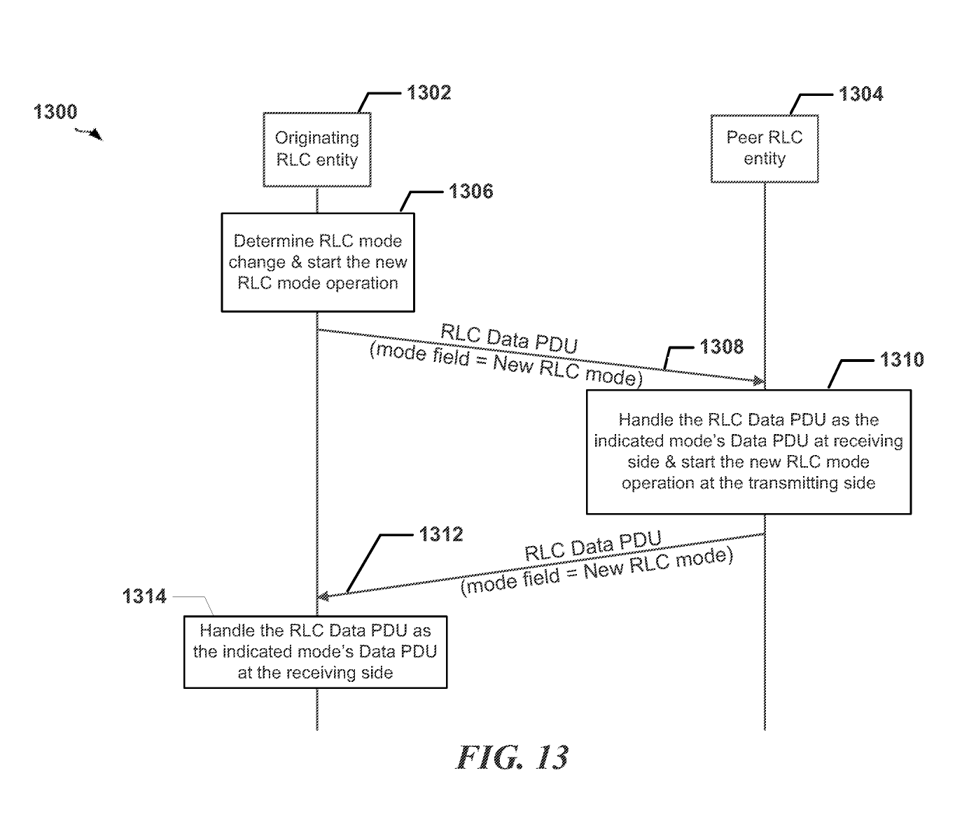

FIG. 13 illustrates a timing diagram 1300 showing interactions between an originating RLC entity 1302 and a receiving or peer RLC entity 1304 that occur in the disclosed combined AM/UM operation. When an RLC entity, such as originating RLC entity 1302, determines an RLC mode change as shown at event or time 1306, the entity 1302 is configured to start operating according to the new RLC mode of operation. The originating RLC entity 1302 then transmits an RLC Data PDU, such as PDU 1200, that indicates through the settings of the P and B bit fields (1206, 1208) to switch to the other new mode (e.g., either AM or UM) as shown by transmission 1308. For example, when RLC entity 1302 determines to switch to no buffering or in-order delivery (e.g., UM) for the receiving RLC entity 1304, the transmitting or originating RLC entity 1302 indicates the change by setting the buffer bit B 1208 to a predetermined value for UM, (e.g., “0” as indicated in Table 1) in an RLC data PDU (e.g., 1200) that is to be transmitted (e.g., 1308). Additionally, it is noted that the transmitting or originating RLC entity 1302 may stop buffering of the RLC Data PDUs if it determines that it will not need to retransmit any PDUs (e.g., B bit=0).

When the receiving or peer RLC entity receives the RLC Data PDU 1308, the RLC data is handled according to the indicated mode, as well as starting the new RLC mode operation as indicated at event or time 1310. In an example, if the B bit is set to the UM value (e.g. B=0), the peer RLC entity 1304 starts using a t-Reordering timer configured for the UM operation, i.e., the time is configured with a shorter timer duration than the AM timer, which enables use of a smaller reception buffer. The peer RLC entity 1304, then send a return RLC Data PDU as indicated by transmission 1312. After the originating RLC entity 1302 receives the data PDU transmission 1312, the entity 1302 handles the RLC Data PDU as the indicated mode's Data PDU at the receiving or peer side as indicated at event or time 1314. In an aspect, the transmission 1312 constitutes a matching complementary indication signal to signal 1308, where the peer RLC entity is including the mode switching information back to the originating RLC entity (or other RLC entities as well).

According to another aspect, when the RLC entity determines a switch from UM to AM, the transmitter RLC entity 1302 indicates the change by setting the B bit to a predetermined value for AM (e.g., “1”) in the RLC Data PDU to be transmitted and starts buffering the RLC Data PDUs as the Buffer B bit is set for AM value as the peer RLC entity may request retransmission of the PDUs. When the receiving side of the peer RLC entity receives an RLC Data PDU with the mode field set to the AM value (e.g. ‘1’) the peer RLC entity starts generating status reports e.g. when a polling bit in the received RLC Data PDU is set and/or when the receiving side of the peer RLC entity detects any missing RLC Data PDU and also starts using a t-Reordering timer configured for the AM operation (which is configured with a longer timer duration than the UM one so that the receiving side can reassemble RLC SDUs from the retransmitted RLC PDUs as well as the previously received RLC PDUs. It is also noted that the peer RLC entity may need to generate status reports even in the UM operation mode so that the transmitting RLC can measure the packet error rate (PER) and/or latency.

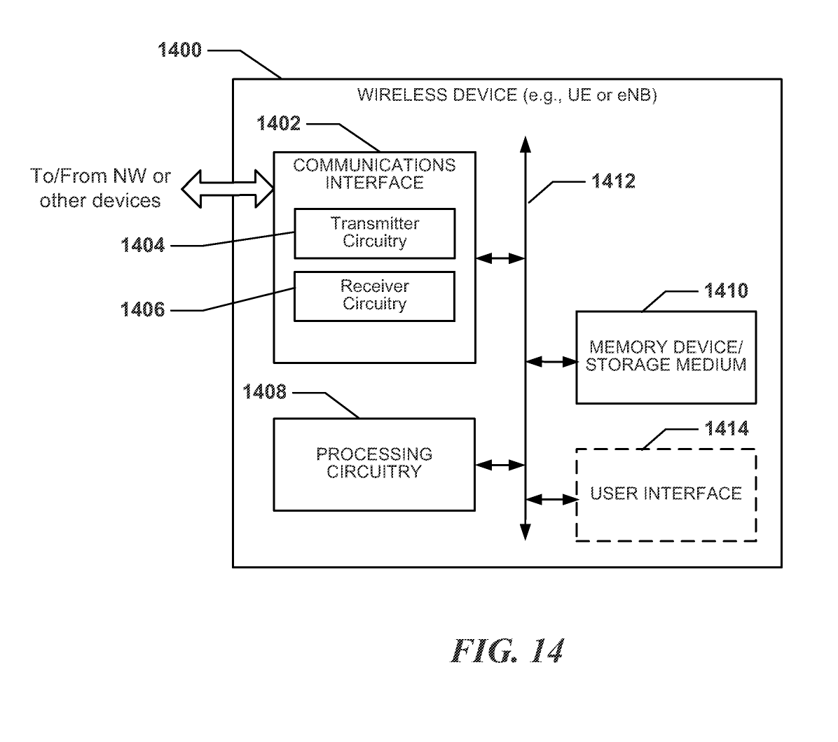

FIG. 14 is a block diagram illustrating an exemplary hardware implementation of a wireless device 1400 that may be configured to perform one or more functions disclosed herein. The device 1400 includes various circuitry and/or logic may be one configuration of a UE or an eNB, as examples. The device 1400 includes a communications interface circuitry 1402, which may include transmitter circuitry 1404 and receiver circuitry 1406. The communications interface circuitry 1402 is further configured to send and receive various signals to and from the network (e.g., network 104 in FIG. 1 through antenna or various antenna arrays (not shown). It is further noted that the communications interface circuitry 1402 may include digital signal processing (DSP) circuitry or logic for effectuating various functions including, but not limited to, at least partial implementation of the various protocol layers in a protocol stack, such as an LTE protocol stack (See e.g., FIG. 3) in conjunction with the transmit and receive circuitry 1404, 1406.

Furthermore, the device 1400 includes processing circuit 1408, which may include application layer processing, as well as other processing and even for implementing portions of the protocol stack in some instances. Furthermore, the device includes a memory device or storage medium 1410 to store various instructions or code executable by the processing circuitry 1408 or other computational apparatus. Moreover, device 1400 may be implemented with a bus architecture or similar communicative couplings, represented generally by the bus 1412. The bus 1412 may include any number of interconnecting buses and bridges depending on the specific application of the processing circuitry 1408, the communications interface circuitry 1402, and the overall design constraints. As illustrated, the bus 1412 links together various circuitry including the communications interface circuitry 1402, processing circuitry 1408, the memory device 1410, and an optional user interface 1414.

Memory device 1410 may include mass storage devices, and also may be referred to as computer-readable media and processor-readable media. The bus 1412 may also link various other circuits such as timing sources, timers, counters, peripherals, voltage regulators, and power management circuits (not shown). Depending upon the nature of the device 1400, the user interface 1414 (e.g., keypad, display, speaker, microphone, joystick, touch panel, etc.) may also be provided, and may be communicatively coupled to the bus 1412.

In accordance with other various aspects of the disclosure, an element, or any portion of an element, or any combination of elements as disclosed herein may be implemented using the processing circuitry 1408. The processing circuit 1408 may include one or more processors controlled by some combination of hardware and software modules. Examples of processors that can be utilized include microprocessors, microcontrollers, digital signal processors (DSPs), field programmable gate arrays (FPGAs), programmable logic devices (PLDs), application specific integrated circuits (ASICs) configured to specifically performed particular functions, system on chips (SOCs), state machines, sequencers, gated logic, discrete hardware circuits, or other suitable hardware configured to perform the various functionalities described in this disclosure.

Processing circuitry 1408 may, at least in part, be responsible for managing the bus 1412 and for general processing that may include the execution of software stored in a computer-readable medium that may reside in the memory device 1410. In this respect, the processing circuitry 1408 may be used to implement any of the methods, functions and techniques disclosed herein. Moreover, the processing circuitry 1408 may execute software. Software shall be construed broadly to mean instructions, instruction sets, code, code segments, program code, programs, subprograms, software modules, applications, software applications, software packages, routines, subroutines, objects, executables, threads of execution, procedures, functions, algorithms, etc., whether referred to as software, firmware, middleware, microcode, hardware description language, or otherwise. The software may reside in computer-readable form in the memory device 1410 or, in some instance, in an external computer readable medium (not shown). The memory device 1410 may include a non-transitory computer-readable medium including, by way of example, a magnetic storage device (e.g., hard disk, floppy disk, magnetic strip), an optical disk (e.g., a compact disc (CD) or a digital versatile disc (DVD) or a BluRay™ disc), a smart card, a flash memory device (e.g., a “flash drive,” a card, a stick, or a key drive), a random access memory (RAM), a read only memory (ROM), a programmable ROM (PROM), an erasable PROM (EPROM), an electrically erasable PROM (EEPROM), a register, a removable disk, and any other suitable medium for storing software and/or instructions that may be accessed and read by a computer. The computer-readable medium and/or storage 1410 may also include, by way of example, a carrier wave, a transmission line, and any other suitable medium for transmitting software and/or instructions that may be accessed and read by a computer. IN an alternative, the storage medium 1410 may reside in the processing circuitry 1408, or be distributed across multiple entities including the processing circuitry 1408.

Still further, the processing circuitry 1408 may be multifunctional, whereby various functions are loaded and the circuitry 1408 is configured to perform different functions or different instances of the same function. The processing circuitry 1408 may additionally be adapted to manage background tasks initiated in response to inputs from the user interface 1414 or the communications interface 1402, for example.

Although not illustrated, the transmit and receive circuitry 1404, 1406 can be coupled to an RF (Radio Frequency) circuit for transmission and reception of signals on the PHY layer. Additionally, the transmit and receive circuitry 1404, 1406 may process and buffer transmitted or received signals, such as for RLC AM operation or when the Buffering bit B is set to “1”.

The following flowcharts illustrate methods and processes performed or operative on network elements adapted or configured in accordance with certain aspects disclosed herein. The methods and processes may be implemented in any suitable network technology, including 3G, 4G, and 5G technologies, to name but a few. Accordingly, the claims are not restricted to a single network technology. In this regard, a reference to a “UE” may be understood to refer also to a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. A reference to an “eNodeB”, “eNB”, “femto cell”, “home Node B”, or “home eNB” may be understood to refer to a base station, a base transceiver station, a radio base station, a radio transceiver, a transceiver function, a basic service set, an extended service set, or some other suitable terminology. A reference to an MME may refer also to an entity that serves as an authenticator in the serving network and/or a primary service delivery node such as a Mobile Switching Center or a Serving GPRS Support Node (SGSN), for example. A reference to the HSS may refer also to a database that contains user-related and subscriber-related information, provides support functions in mobility management, call and session setup, and/or user authentication and access authorization, including, for example, a Home Location Register (HLR), Authentication Center (AuC) and/or an authentication, authorization, and accounting (AAA) server.

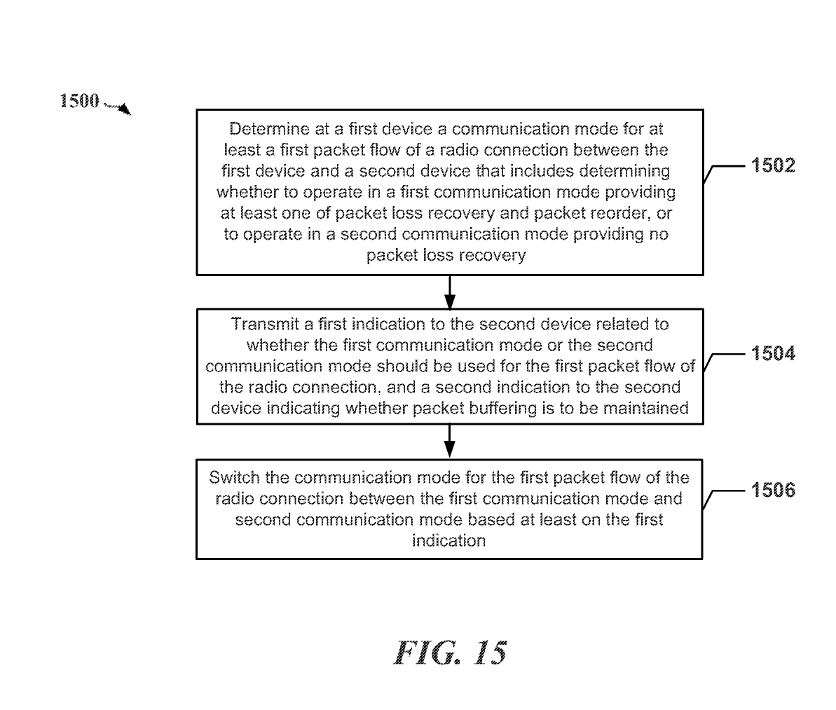

FIG. 15 is a flow diagram of an exemplary method for wireless communication 1500 that may be performed at a first device, such as an originating RLC device. At block 1502, the first device determines a communication mode for a radio bearer connection or at least a first packet flow in a radio connection between the first device (e.g., an originating RLC entity) and a second device (e.g., a peer RLC entity) that includes determining whether to operate in a first communication mode providing at least one of packet loss recovery and packet reorder (e.g., AM), or to operate in a second communication mode providing no packet loss recovery (e.g., UM). This process in block 1502 may correspond to the RLC mode change event 806 in FIG. 8 or the RLC mode change determination 1306 in FIG. 13, as a couple of examples.

The method 1500 further includes transmitting a first indication from the first device to the second device, where the indication is related to whether the first communication mode or the second communication mode should be used for the first packet flow in the radio connection as illustrated in block 1504. As an example, this first indication may include signaling 808 in FIG. 8 or signaling 1308 in FIG. 13, as a couple of examples. Furthermore, the first indication may be implemented through the PDU header information illustrated in FIGS. 10 and 11, whether that be a data PDU or a status PDU. Furthermore, the first indication could be the Poll bit P in the PDU of FIG. 12. The transmission in block 1504 also includes a second indication to the second device indicating whether packet buffering is to be maintained. As an example, this second indication may be buffer bit B illustrated in FIG. 12. Thus, it will be further appreciated that the combination of the first indication as a Poll bit and the second indication as a buffer bit B can be used to provide indication signaling to a peer RLC entity to switch modes communicated by the combination of these bits, as discussed before.

Still further, method 1500 includes the process illustrated in block 1506 where the communication mode for the first packet flow in the radio connection is switched between the first communication mode and second communication mode based at least on the first indication. As examples, this process could correspond to events 812 or 818 in FIG. 8, or events 1310 or 1314 in FIG. 13.

In another example, the first device may receive an acknowledgment from the second device in response to transmitting the indication. The first device would then only switch operation of the first packet flow in the radio connection after the acknowledgment is received. The first device may also reset one or more state elements associated with the first packet flow in the radio connection in response to receiving the acknowledgment, the state elements including at least one of variables, counters and/or timers. The first device may also set a retransmit timer to retransmit the indication if an acknowledgment is not received prior to the expiration of the retransmit timer.

In yet another example, at least one of the indications further indicates whether the first device is buffering packets for recovering. A transmitter buffers data just for retransmission. Reordering is a receiver-specific function that has nothing to do with transmitter functions on the transmitter side.

According to another example, the determination of whether to operate in the first communication mode or in the second communication mode is performed by a transmitter of the first device.

In another example, the determination of whether to operate in the first communication mode or in the second communication mode is performed by a receiver of the first device.

According to another aspect, the protocol layer is one layer in a multi-layer protocol stack, and the protocol layer is at least one of: (a) a radio link control (RLC) layer, (b) a medium access control (MAC) layer, or (c) a packet data convergence protocol (PDCP) layer.

In yet another aspect, the first device may switch from the first communication mode to the second communication mode when a memory usage of the first device exceeds a predetermined threshold. In still another example, the first device may switch from the first communication mode to the second communication mode when usage of a transmitter or receiver buffer of the first device exceeds a predetermined threshold.

According to another example, the first device may also perform a user-plane measurement over the first packet flow of the radio connection, wherein the determination of whether to operate in the first communication mode or in the second communication mode is based on the user-planed measurement, and the user-plane measurement includes at least one of a data rate, a buffer size, a packet error rate (PER) and/or a block error rate (BLER). The first device may also compare the user-plane measurement to a threshold to determine whether to operate in the first communication mode or in the second communication mode.

In another example, the determination of whether to operate in the first communication mode or in the second communication mode is based on a latency between the first device and the second device, or a measured end-to-end latency between a first peer end of a first application layer of the first device and a second peer end of a second application layer of the second device.

In another example, the determination of whether to operate in the first communication mode or in the second communication mode is based on a number of internet protocol (IP) flows currently active over the first packet flow in the radio connection.

In another example, the first communication mode includes an acknowledged mode (AM) and the second communication mode includes an unacknowledged mode (UM). However, this UM may not be exactly the same as the UM in RLC because that UM still generated status PDUs to the peer RLC entity.

In yet one more example, at least one of the indications is sent within: (a) a radio link control (RLC) layer status protocol data unit (PDU), (b) a radio resource control (RRC) message, (c) a bit in a radio link control (RLC) layer PDU, (d) a packet data convergence protocol (PDCP) status PDU, (e) a bit in a PDCP data PDU, (f) a medium access control (MAC) control element, or (g) a bit in a MAC PDU.

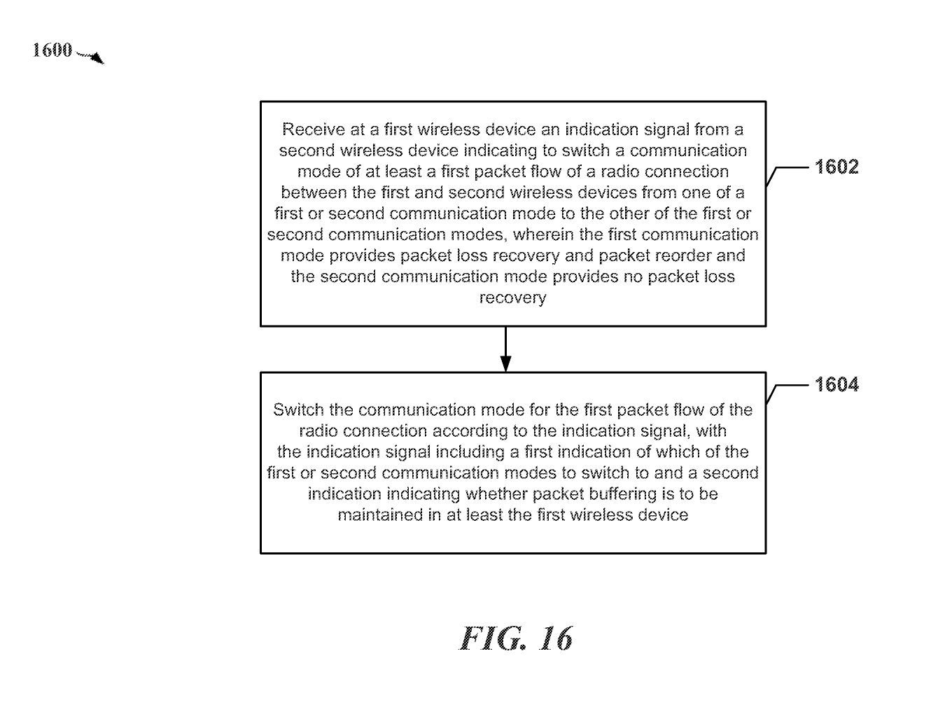

FIG. 16 is a flow chart of a method of wireless communication 1600 performed at a wireless communications device, such as a peer RLC entity at a receiving end of a radio bearer connection or a packet flow in a radio connection. As illustrated, method 1600 illustrates a process at block 1602 including receiving at a first wireless device an indication signal from a second wireless device indicating to switch a communication mode of a first packet flow in radio connection between the first and second wireless devices from one of a first or second communication mode to the other of the first or second communication modes, wherein the first communication mode provides packet loss recovery and packet reorder and the second communication mode provides no packet loss recovery. It is noted that according to a couple example, the process in block 1602 may include signaling 808 and event 812 in FIG. 8 or signaling 1308 or 1312 and events 1310 or 1312 in FIG. 13.

The method 1600 further includes a process illustrated in block 1604 of switching the communication mode for the first packet flow in the radio connection according to the indication signal. Furthermore, the indication signal includes a first indication of which of the first or second communication modes to switch to and a second indication indicating whether packet buffering is to be maintained in at least the first wireless device

In another example, the wireless communications device may also send an acknowledgment to the second wireless communications device in response to receiving the indication.

In another example, the wireless communications device may also withhold transmission of an acknowledgment, in response to receipt of the indication, to prevent the second wireless communications device from switching operation of the first packet flow in the radio connection.

In another example, the wireless communications device may reset one or more state elements associated with the first packet flow in the radio connection in response to receiving the indication, the state elements including at least one of variables, counters, and/or timers.

In another example, the indication signaling further indicates whether the second wireless communications device is buffering packets for recovering. A transmitter buffers data just for retransmission. Reordering is a receiver-specific function that has nothing to do with transmitter functions on the transmitter side.

In another example, the first communication mode includes an acknowledged mode (AM) and the second communication mode includes an unacknowledged mode (UM). However, this UM may not be exactly the same as the UM in RLC because that UM still generated status PDUs to the peer RLC entity.

In another example, the protocol layer is one layer in a multi-layer protocol stack, and the protocol layer is at least one of: (a) a radio link control (RLC) layer, (b) a medium access control (MAC) layer, or (c) a packet data convergence protocol (PDCP) layer.

In another example, the indication signaling is sent within: (a) a radio link control (RLC) layer status protocol data unit (PDU), (b) a radio resource control (RRC) message, (c) a bit in a radio link control (RLC) layer PDU, (d) a packet data convergence protocol (PDCP) status PDU, (e) a bit in a PDCP data PDU, (f) a medium access control (MAC) control element, or (g) a bit in a MAC PDU. In another example, the indication is received via either a control signal (e.g., a control or status PDU) or an in-band signal (e.g., a data PDU).

It is understood that the specific order or hierarchy of steps in the processes disclosed is an illustration of exemplary approaches. Based upon design preferences, it is understood that the specific order or hierarchy of steps in the processes may be rearranged. Further, some steps may be combined or omitted. The accompanying method claims present elements of the various steps in a sample order, and are not meant to be limited to the specific order or hierarchy presented.

The present description is provided to enable any person skilled in the art to practice the various aspects and examples described herein. Various modifications to these aspects and examples will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed as a means plus function unless the element is expressly recited using the phrase “means for.”

What is claimed is:

1. A method for wireless communication comprising:
determining at a first device a communication mode for at least a first packet flow of a radio connection between the first device and a second device that includes determining whether to operate in a first communication mode providing at least one of packet loss recovery and/or packet reorder, or to operate in a second communication mode providing no packet loss recovery;
transmitting a first indication to the second device related to whether the first communication mode or the second communication mode should be used for the first packet flow of the radio connection, and a second indication to the second device indicating whether packet buffering is to be maintained; and
switching the communication mode for the first packet flow of the radio connection between the first communication mode and second communication mode based at least on the first indication.

2. The method of claim 1, further comprising:
receiving an acknowledgement from the second device in response to transmitting the first indication.

3. The method of claim 2, wherein the first device switches the communication mode of the first packet flow of the radio connection after the acknowledgement is received.

4. The method of claim 1, wherein switching the communication mode for the radio connection further comprises:
resetting one or more state elements associated with the first packet flow of the radio connection in at least one of the first and second devices, the state elements including at least one of state variables, counters, and/or timers.

5. The method of claim 1, wherein the first indication comprises information in at least one of in-band signaling and/or control signaling indicating at least one of a request for communication mode change and/or the communication mode to which to be switched.

6. The method of claim 1, wherein the second indication comprises a buffer bit in a header of a Protocol Data Unit (PDU) that signals whether or not to buffer packets in at least one of the first device and/or the second device.

7. The method of claim 6, further comprising:
the first indication including a poll bit indicating whether to send a status of one or more received PDUs over the first packet flow of the radio connection; and
wherein a combination of the poll bit and the buffer bit are configured to communicate switching the communication mode for the first packet flow of the radio connection between the first communication mode and second communication mode.

8. The method of claim 1, wherein determining whether to operate in the first communication mode or the second communication mode further comprises:
measuring at least one of a data rate of the first packet flow of the radio connection, a buffer size in at least one of the first and second devices, a packet error rate (PER), a block error rate (BLER), packet latency between the first and second devices over the first packet flow of the radio connection, and/or a number of internet protocol (IP) flows served on the first packet flow of the radio connection; and
determining whether to operate in the first communication mode or the second communication mode based on the measuring.

9. The method of claim 1, wherein the first communication mode is a Radio Link Control (RLC) acknowledged mode (AM) and the second communication mode is an RLC unacknowledged mode (UM).

10. A wireless device, comprising:
a communications interface configured to communicate over a wireless network; and
processing circuitry coupled to the communications interface, the processing circuitry configured to:
determine a communication mode for at least a first packet flow of a radio connection between the wireless device and another second wireless device that includes determining whether to operate in a first communication mode providing at least one of packet loss recovery and/or packet reorder, or to operate in a second communication mode providing no packet loss recovery;
transmit a first indication to the second wireless device related to whether the first communication mode or the second communication mode should be used for the first packet flow of the radio connection, and a second indication to the second wireless device indicating whether packet buffering is to be maintained; and
switch the communication mode for the first packet flow of the radio connection between the first communication mode and second communication mode based at least on the first indication.

11. The wireless device of claim 10, the processing circuitry further configured to receive an acknowledgement from the second wireless device in response to transmitting the first indication.

12. The wireless device of claim 11, wherein the processing circuitry switches the communication mode of the first packet flow of the radio connection after the acknowledgement is received.

13. The wireless device of claim 11, wherein the processing circuitry is further configured to:
switch the communication mode for the first packet flow of the radio connection including resetting one or more state elements associated with the first packet flow of the radio connection in at least one of the wireless device and second wireless device, the state elements including at least one of state variables, counters, and/or timers.

14. The wireless device of claim 10, wherein the first indication comprises information in at least one of in-band signaling and control signaling indicating at least one of a request for communication mode change and/or the communication mode to which to be switched.

15. The wireless device of claim 10, wherein the second indication comprises a buffer bit in a header of a Protocol Data Unit (PDU) that signals whether or not to buffer packets in at least one of the wireless device and/or the second wireless device.

16. The wireless device of claim 15, further comprising:
the first indication including a poll bit indicating whether to send a status of one or more received PDUs over the first packet flow of the radio connection; and
wherein a combination of the poll bit and the buffer bit are configured to communicate switching the communication mode for the first packet flow of the radio connection between the first communication mode and second communication mode.

17. The wireless device of claim 10, wherein the processing circuitry is further configured to:
measure at least one of a data rate of the first packet flow of the radio connection, a buffer size in at least one of the wireless device and the second wireless device, a packet error rate (PER), a block error rate (BLER), packet latency between the first and second devices over the first packet flow of the radio connection, and/or a number of internet protocol (IP) flows served on the first packet flow of the radio connection; and
determine whether to operate in the first communication mode or the second communication mode based on the measuring.

18. The wireless device of claim 10, wherein the first communication mode is a Radio Link Control (RLC) acknowledged mode (AM) and the second communication mode is an RLC unacknowledged mode (UM).

19. A method for wireless communication, comprising:
receiving at a first wireless device an indication signal from a second wireless device indicating to switch a communication mode of a first packet flow of a radio connection between the first and second wireless devices from one of a first or second communication mode to the other of the first or second communication modes, wherein the first communication mode provides packet loss recovery and packet reorder and the second communication mode provides no packet loss recovery; and
switching the communication mode for the first packet flow of the radio connection according to the indication signal;
wherein the indication signal includes a first indication of which of the first or second communication modes to switch to and a second indication indicating whether packet buffering is to be maintained in at least the first wireless device.

20. The method of claim 19, further comprising:
sending an acknowledgement from the first wireless device to the second wireless device in response to the received indication signal.

21. The method of claim 19, wherein switching the communication mode for the first packet flow of the radio connection further comprises:
resetting one or more state elements associated with the first packet flow of the radio connection in at least the first wireless device responsive to the indication signal, the state elements including at least one of state variables, counters, and/or timers.

22. The method of claim 19, wherein the indication signal comprises information in at least one of in-band signaling and control signaling from the second wireless device indicating at least one of a request for communication mode change and/or the communication mode to which to be switched.

23. The method of claim 19, wherein the second indication comprises a buffer bit in a header of a Protocol Data Unit (PDU) from the second wireless device that signals whether or not to buffer packets in at least the first device.

24. The method of claim 23, further comprising:
the first indication including a poll bit indicating whether to send a status from the first wireless device to the second wireless device of one or more received PDUs over the first flow of the radio connection; and
wherein a combination of the poll bit and the buffer bit are configured to communicate switching the communication mode for the first flow of the radio connection between the first communication mode and second communication mode.

25. The method of claim 23, wherein the first communication mode is a Radio Link Control (RLC) acknowledged mode (AM) and the second communication mode is an RLC unacknowledged mode (UM).

26. A wireless communications device, comprising:
a communications interface configured to communicate over a wireless network; and
processing circuitry communicatively coupled to the communications interface, the processing circuitry configured to:
receive an indication signal from a second wireless communications device indicating to switch a communication mode of at least a first packet flow of a radio connection between the wireless communications device and the second wireless communications device from one of a first or second communication mode to the other of the first or second communication modes, wherein the first communication mode provides packet loss recovery and packet reorder and the second communication mode provides no packet loss recovery; and
switch the communication mode for the first packet flow of the radio connection according to the indication signal;
wherein the indication signal includes a first indication of which of the first or second communication modes to switch to and a second indication indicating whether packet buffering is to be maintained in at least the wireless communications device.

27. The wireless communications device of claim 26, the processing circuitry further configured to:
send an acknowledgement from the wireless communications device to the second wireless communications device in response to the received indication signal.

28. The wireless communications device of claim 26, wherein the indication signal comprises information in at least one of in-band signaling and control signaling from the second wireless communications device indicating at least one of a request for communication mode change and/or the communication mode to which to be switched.

29. The wireless communications device of claim 26, further comprising:
the first indication including a poll bit indicating whether to send a status from the wireless communications device to the second wireless communications device of one or more received Protocol Data Units (PDUs) received over the first packet flow of the radio connection; and
the second indication including a buffer bit in a header of a from the second wireless communications device that signals whether or not to buffer packets at the wireless communications device;
wherein a combination of the poll bit and the buffer bit are configured to communicate switching the communication mode for the first packet flow of the radio connection between the first communication mode and second communication mode.

30. The wireless communications device of claim 26, the processing circuitry further configured to:
send a complementary indication signal matching the received indication signal to the second wireless communications device after switching the communication mode for the first packet flow of the radio connection in response to the indication signal received from the second wireless communications device.
